(19) United States
(12) Patent Application Publication
(10) Pub. No.: US 2025/0156948 A1
(43) Pub. Date: May 15, 2025

(54) DIGITAL PLATFORMS FOR GENERATING, REDEEMING, AND EXCHANGING TOKENIZED REPRESENTATIONS OF TANGIBLE ASSET OWNERSHIP

(71) Applicant: CERTIFIEDNFT US, LLC, Miami, FL (US)

(72) Inventors: Nathaniel Smith, Hightstown, NJ (US); Hamilton Souther, Campbell, CA (US); Randall Johnson, Stone Mountain, GA (US)

(21) Appl. No.: 18/856,350

(22) PCT Filed: Apr. 7, 2023
(86) PCT No.: PCT/US2023/017911

§ 371 Date: Oct. 11, 2024

Related U.S. Application Data
(60) Provisional application No. 63/328,687, filed on Apr. 7, 2022.

(51) Int. Cl. G06Q 40/04; H04L 9/06

(52) U.S. Cl. CPC G06Q 40/04; H04L 9/0643; G06Q 2220/10

(57) ABSTRACT

The disclosed embodiments include computer-implemented apparatuses and processes that securely generate, redeem, and transfer ledger-based non-fungible tokens (NFTs) representative of an ownership of corresponding, tangible or digital assets. For example, an apparatus may receive, from a device, a request to generate a non-fungible token associated with an ownership interest in an asset that includes first data characterizing the ownership interest, and may receive, from a computing system, elements of second data that characterize the ownership interest. Based on a determined consistency between the first and second data, the apparatus may perform operations that generate the non-fungible token and that record information characterizing the non-fungible token within an element of a distributed ledger, and may provision the non-fungible token to an application program executed by the device

### CROSS-REFERENCE TO RELATED APPLICATION

This application claims the benefit of priority to U.S. Application No. 63/328,687, filed Apr. 7, 2022, the disclosure of which is incorporated herein by reference to its entirety.

### TECHNICAL FIELD

The disclosed embodiments generally relate to computer-implemented digital platforms for generating, redeeming, and transferring tokenized representations of asset ownership.

### BACKGROUND

Trading of real world assets poses several challenges, including verification of records and proof of ownership of the real world assets, authentication of the real world assets and collaboration among different entities. Apart from verification of the records for the real world assets, authenticating the location and present condition of the real world asset is also a challenge.

### SUMMARY

In some examples, an apparatus includes a communications interface, a memory storing instructions, and at least one processor coupled to the communications interface and to the memory. The at least one processor is configured to execute the instructions to receive, from a device via the communications interface, a request to generate a non-fungible token associated with an ownership interest in an asset. The request includes elements of first data that characterize the ownership interest. The at least one processor is further configured to execute the instructions to receive, from a computing system via the communications interface, elements of second data that characterize the ownership interest, and based on a determined consistency between the elements of first and second data, perform operations that generate the non-fungible token and that record information characterizing the non-fungible token within an element of a distributed ledger. The at least one processor is further configured to execute the instructions to perform operations that provision the non-fungible token to an application program executed by the device.

Additionally, in some examples, an apparatus includes a communications interface, a memory storing instructions, and at least one processor coupled to the communications interface and to the memory. The at least one processor is configured to execute the instructions to receive, from a device via the communications interface, a request to redeem a non-fungible token associated with an ownership interest in an asset. The request includes the non-fungible token. The at least one processor is further configured to execute the instructions to, based on the request, verify the ownership interest in the asset and that determine an availability of the non-fungible token for redemption, and based on the verified ownership interest in the asset and on the determined availability of the non-fungible token, generate a hash value representative of at least a portion of the non-fungible token, and perform operations that record the hash value and information characterizing the non-fungible token within an element of a distributed ledger. The at least one processor is further configured to execute the instructions to perform operations that provision encrypted data to a computing system associated with the asset. The computing system is configured to decrypt the encrypted data and perform operations that trigger a release of documentation data associated with the ownership interest.

Further, in some examples, an apparatus includes a communications interface, a memory storing instructions, and at least one processor coupled to the communications interface and to the memory. The at least one processor is configured to execute the instructions to receive, via the communications interface, a request to transfer a non-fungible token associated with an ownership interest in an asset from a first device to a second device. The request includes an identifier of transfer data, data identifying the second device, and a value of at least one parameter of the transfer. The at least one processor is further configured to execute the instructions to, based on portions of the request, approve the transfer of the non-fungible token, and perform operations that record information characterizing the approved transfer of the non-fungible token within an element of a distributed ledger. The at least one processor is further configured to execute the instructions to perform operations that provision the non-fungible token to an application program executed by the second device.

### BRIEF DESCRIPTION OF THE DRAWINGS

FIG. 1 is a block diagram illustrating a portion of an exemplary computing environment, in accordance with some exemplary embodiments.

FIG. 2 is a flowchart of an exemplary process for minting a ledger-based, non-fungible token (NFT) representative of a legally valid ownership of a corresponding real-world asset, in accordance with some exemplary embodiments.

FIG. 3 is a flowchart of an exemplary process for minting a ledger-based, hybrid non-fungible token (NFT), in accordance with some exemplary embodiments.

FIG. 4 is a flowchart of an exemplary process for transferring indirectly ownership of ledger-based non-fungible tokens (NFTs) using a certified NFT exchange, in accordance with some exemplary embodiments.

FIG. 5 is a flowchart of an exemplary process for burning a ledger-based non-fungible token (NFT), in accordance with some exemplary embodiments.

Like reference numbers and designations in the various drawings indicate like elements.

### DETAILED DESCRIPTION

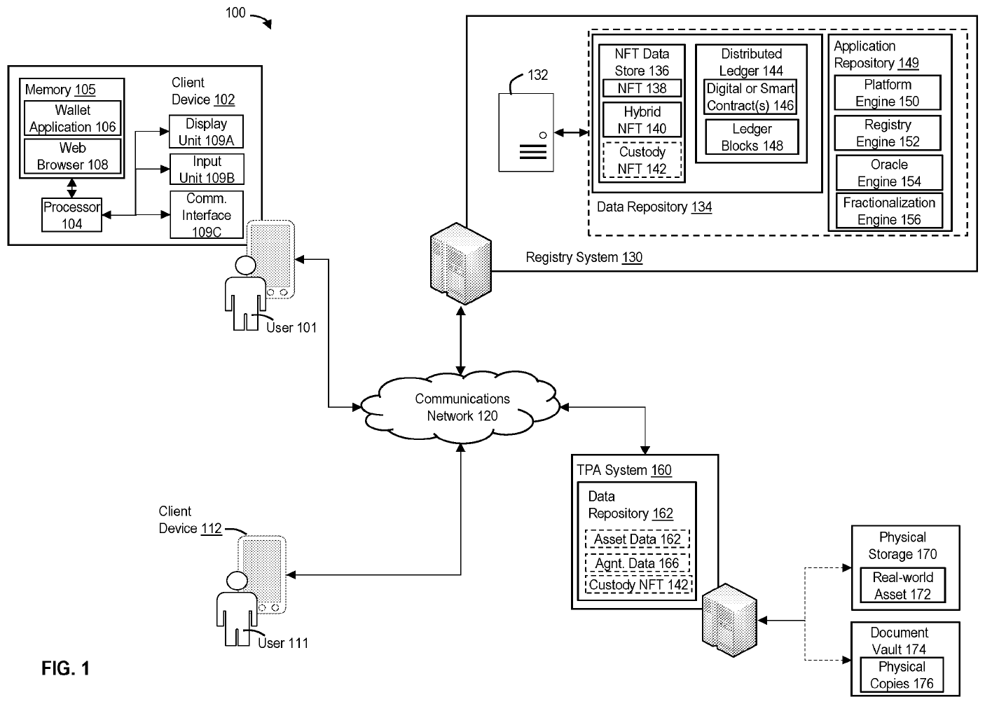

FIG. 1 is a diagram of an exemplary computing environment 100 that includes, among other things, one or more computing devices, such as, client devices 102 and 112, and one or more computing systems, such as a registry system 130 and a third-party administrator (TPA) system 160. Each of the client devices, including client devices 102 and 112, and each of the computing systems, including registry system 130 and TPA system 160, may be operatively connected to, and interconnected across, one or more communications networks, such as the communications network 120. Examples of communications network 120 include, but are not limited to, a wireless local area network (LAN), e.g., a “Wi-Fi” network, a network utilizing radio-frequency (RF) communication protocols, a Near Field Communication (NFC) network, a wireless Metropolitan Area Network (MAN) connecting multiple wireless LANs, and a wide area network (WAN), e.g., the Internet. Further, in some instances, the computing devices and systems operating within computing environment 100 may perform operations that establish and maintain one or more secure channels of communication across communications network 120, such as, but not limited to, a transport layer security (TSL) channel, a secure socket layer (SSL) channel, or any other suitable secure communication channel.

By way of example, client device 102 may include a computing device having one or more tangible, non-transitory memories, such as a memory 105, that stores data and/or software instructions, and one or more processors, e.g., a processor 104, configured to execute the software instructions. The one or more tangible, non-transitory memories may, in some aspects, store software applications, application modules, and other elements of code executable by the one or more processors, such as, but not limited to, an executable mobile wallet application 106 or an executable web browser 108 (e.g., Google Chrome™, Apple Safari™, etc.). In some instances, upon execution by the one or more processors of client device 102 (e.g., processor 104), executed wallet application 106 and/or executed web browser 108 may perform any of the exemplary processes described herein, either individually or in conjunction with one or more of registry system 130 or TPA system 160, to generate or “mint” a ledger-based, non-fungible token (NFT) representative of a legally valid ownership of a corresponding tangible, real-word or digital asset, to initiate or participate in an exchange-based or peer-to-peer trade of one or more of the minted NFTs, and to redeem or “burn” a corresponding one of the minted NFTs to receive the underlying tangible, real-world or digital asset and any associated title documents (e.g., in digital or physical form). Further, although not illustrated in FIG. 1, memory 105 may also include one or more structured or unstructured data repositories or databases, and client device 102 may maintain one or more elements of device data within the one or more structured or unstructured data repositories or databases. For example, the elements of device data may uniquely identify client device 102 within computing environment 100, and may include, but are not limited to, an Internet Protocol (IP) address assigned to client device 102 or a media access control (MAC) layer assigned to client device 102.

Client device 102 may include a display unit 109A configured to present interface elements to a corresponding user, such as a user 101, and an input unit 109B configured to receive input from user 101, e.g., in response to the interface elements presented through display unit 109A. By way of example, display unit 109A may include, but is not limited to, an LCD display unit or other appropriate type of display unit, and input unit 109B may include, but is not limited to, a keypad, keyboard, touchscreen, voice activated control technologies, or appropriate type of input unit. Further, in additional aspects (not illustrated in FIG. 1), the functionalities of display unit 109A and input unit 109B may be combined into a single device, e.g., a pressure-sensitive touchscreen display unit that presents interface elements and receives input from user 101. Client device 102 may also include a communications interface 109C, such as a wireless transceiver device, coupled to processor 104 and configured by processor 104 to establish and maintain communications with communications network 120 via one or more communication protocols, such as WiFi®, Bluetooth®, NFC, a cellular communications protocol (e.g., LTE®, CDMA®, GSM®, etc.), or any other suitable communications protocol.

Further, although not illustrated in FIG. 1, client device 112 may also include a computing device having one or more tangible, non-transitory memories that store data and/or software instructions, and one or more processors configured to execute the software instructions. The one or more tangible, non-transitory memories may, in some instances, store application programs, application engines or modules, and other elements of code executable by the one or more processors, such as, but not limited to, the executable initial wallet and applications and web browsers described herein. Further, client device 112 may also include a display unit configured to present interface elements to a corresponding user, such as, user 111, and an input unit configured to receive input from user, e.g., in response to the interface elements presented through the corresponding display unit. Further, client device 112 may also include a communications interface, such as a wireless transceiver device, coupled to, and configured by, the one or more processors to establish and maintain communications with communications network 120 via one or more communication protocols, such as WiFi®, Bluetooth®, NFC, a cellular communications protocol (e.g., LTE®, CDMA®, GSM®, etc.), or any other suitable communications protocol.

Examples of client devices 102 and 112 may include, but not limited to, a personal computer, a laptop computer, a tablet computer, a notebook computer, a hand-held computer, a personal digital assistant, a portable navigation device, a mobile phone, a smart phone, a wearable computing device (e.g., a smart watch, a wearable activity monitor, wearable smart jewelry, and glasses and other optical devices that include optical head-mounted displays (OHMDs)), an embedded computing device (e.g., in communication with a smart textile or electronic fabric), and any other type of computing device that may be configured to store data and software instructions, execute software instructions to perform operations, and/or display information on an interface device or unit, such as display unit 109A. Further, the user 101 may operate the client device 102, and user 111 may operate client device 112, to perform one or more exemplary processes described herein.

Further, each of registry system 130, TPA system 160, and additional, or alternate, ones of the computing system that operate within environment 100 may represent a computing system that includes one or more servers and tangible, non-transitory memory devices storing executable code and application modules. The one or more servers may each include one or more processors or processor-based computing devices, which may be configured to execute portions of the stored code or application modules to perform operations consistent with the disclosed embodiments. For example, as illustrated in FIG. 1, the one or more servers of registry system 130 may include server 132 having one or more processors configured to execute portions of the stored code, application engines, or application modules maintained within the one or more corresponding, tangible, non-transitory memories. In some instances, one or more of registry system 130, TPA system 160, and the additional, or alternate, computing systems may correspond to a discrete computing system, as described herein. In other examples, one or more of registry system 130, TPA system 160, and the additional, or alternate, computing systems may correspond to a distributed system that includes computing components distributed across one or more networks, such as communications network 120, or other networks, such as those provided or maintained by cloud-service providers (e.g., Google Cloud™, Microsoft Azure™, etc.). Further, each of registry system 130, TPA system 160, and the additional, or alternate, computing systems may include a communications unit or interface coupled to the one or more processors for accommodating wired or wireless communication across communications network 120 with any of the additional network-connected systems or devices described herein, e.g., a transceiver device.

In some instances, registry system 130 may perform any of the exemplary processes described herein, in conjunction with TPA system 160 and the application programs executed by client device 102 and/or client device 112, to enhance security and safety, and a legality, of ledger-based non-fungible tokens (NFTs) representative of an ownership of corresponding, tangible, real-world assets and additionally, or alternatively, corresponding digital assets. By way of example, the tangible, real-world assets may include, but are not limited to, parcels of real property (including land, buildings, or other improvements), vehicles (e.g., automobiles, airplanes, yachts, etc.), pieces of artwork (e.g., painting, sculptures, etc.), or other physical objects or assets. In some examples, the tangible, real-world assets may also include one or more units of a precious metal, such as gold, silver, or platinum (e.g., as physical bars, physical coins, etc.), units of raw or processed gemstones, such as diamonds, or units or other precious commodities, such as, but not limited to rare-earth metals, minerals, or materials. Further, by way of example, the digital assets may include, but are not limited to, elements of digital artwork or music, units or cryptocurrencies, or other digital assets.

Further, in some instances, one or more of the tangible, real-world assets may also be representative of a corresponding intangible asset or a corresponding digital asset, and may corresponding to a tangible representation of that intangible or digital asset. Examples of these tangible representations may include, but are not limited to, physical stock certificates representative of a shareholder's ownership in a company, physical warrants representative of a holder's right to buy shares of a company for a specific price within a set window of time or on a specific date, or physical copies of bearer bonds and corresponding coupons.

Each of the tangible, real-world assets, and in some instances, one or more of the digital assets, may be associated with title documents that establish an ownership of corresponding ones of the real-world assets by an individual or organizational entity (e.g., user 101 or user 111, etc.). Further, and as described herein, the ledger-based NFTs may include a “hybrid” NFT that represents both an ownership of a corresponding, tangible real-world asset, plus a high-definition and three-dimensional graphical representation of the tangible real-world asset, which may be provable as accurate and transported into, or used within, a metaverse or other digital environment.

Further, and through an implementation of one or more of the exemplary processes described herein (e.g., based on an execution of software instructions within corresponding smart contracts recorded immutably within one or more ledger blocks of a distributed or blockchain ledger), registry system 130 may perform operations that generate or “mint” a ledger-based, non-fungible token (NFT) representative of a legally valid ownership of a corresponding tangible, real-word asset or digital asset, that facilitate exchange-based or peer-to-peer transfer of one or more of the minted NFTs between owners, and that facilitate a redemption or a “burn” of a corresponding one of the minted NFTs (e.g., which releases an underlying tangible, real-world asset or digital asset and any associated title document to a corresponding owner). In some instances, registry system 130 may perform operations that record, within one or more ledger blocks of the distributed ledger, data characterizing the minting of a corresponding one of the ledger-based NFTs on behalf of an initial owner, each transaction, trade, or exchange of that corresponding, ledger-based NFT across one or temporal intervals, and the final burning of the corresponding, ledger-based NFT, and a redemption of an underlying tangible, real-world asset or digital asset and corresponding title documents, by a subsequent owner.

In some instances, registry system 130 may also broadcast, across communications network 120, portions of the data characterizing the minting of a corresponding one of the ledger-based NFTs on behalf of the initial owner, each transaction, trade, or exchange of that corresponding, ledger-based NFT across one or temporal intervals, and the final burning of the corresponding, ledger-based NFT to one or more additional computing systems (not illustrated in FIG. 1). As described herein, registry system 130 and the one or more additional computing systems may collectively form a portion of a distributed-ledger network, and each of registry system 130 and the one or more additional computing systems may maintain a local version of the distributed ledger within a corresponding tangible, non-transitory memory. Further, and upon receipt of the portions of broadcast data, one or more of registry system 130 and the additional computing systems may perform consensus-based operations that record the received portions of the broadcast data within the one or more ledger elements of the distributed ledger (e.g., based on a computed proof-of-work or proof-of-stake, etc.), which may establish an “updated” distributed ledger, and one or more of registry system 130 and the additional computing

may broadcast the updated distributed ledger across communications network 120 to the other components of the distributed-ledger network. In other instances, registry system 130 (or a corresponding one of the additional computing systems) may perform operations that establish, maintain, or update the distributed ledger directly and without consensus-based processing, and may broadcast the updated distributed ledger across communications network 120 to the other components of the distributed-ledger network.

The recordation of the data characterizing the minting, the trading, and the eventual burning of corresponding ones of the ledger-based NFTs, (including the hybrid NFTs described herein), may establish, a cryptographically secure, immutable, auditable record of the corresponding, ledger-based NFTs, and the ownership of the underlying tangible, real-world assets or digital assets (the associated title documentation), across multiple temporal intervals. In some instances, the recordation within the ledger blocks of the distributed or blockchain ledger of transfer dates and transfer prices characterizing transfers of the corresponding ones of the ledger-based NFTs across multiple temporal intervals may establish, within the ledger bocks of the distributed or blockchain ledger, a historical registry of NFT transfer prices across the multiple temporal intervals.

Certain of the exemplary processes described herein, when implemented by registry system 130 in conjunction with TPA system 160 and application programs executed by client devices 102 or 112, may, among other things: (i) enhance direct legal rights between ledger-based NFT and corresponding tangible, real-world assets or digital assets (and the ownership of the corresponding real-world or digital assets); (ii) facilitate a secure maintenance of the “correct” legal title and transfer documents associated with a tangible, real-world asset or a digital asset represented by a corresponding, ledger-based NFT within an inviolate escrow or trust for the benefit of a current owner of the corresponding, ledger-based NFT; (iii) reduce a “counterparty risk” of having the “correct” legal title and transfer documents held by humans or organizations; (iv) provision access to one or more unrelated individuals access, in real-time, to digital images characterizing a current condition or location of a tangible, real-world asset represented by a corresponding, ledger-based hybrid NFT, and information characterizing a financial condition, insurance protection, escrow balance, and/or other relevant information of the real-world asset; (v) establish and maintained a registry of the historical NFT transfer prices within a distributed or blockchain ledger; and (vi) enhance a transferability of the ledger-based NFTs described herein over current and future temporal interval by facilitating a protection and documentation of corresponding ones of the tangible, real-world assets or digital assets, and confirming a timely payment of taxes and insurance for corresponding ones of the tangible, real-world assets or digital assets. One or more of these exemplary processes may be implemented in addition to, or as an alternate to, existing, insecure, informal, and ad-hoc processes for transferring an ownership of tangible, real-world or digital assets between parties.

Referring back to FIG. 1, and to perform any of the exemplary processes described herein, third-party administrator (TPA) system 160 may maintain, within the one or more tangible, non-transitory memories, a data repository 162 that includes elements of asset data 163 and agreement data 166. As described herein, TPA system 160 may be associated with, or operated by, a third-party administrator associated with one or more of the tangible, real-world assets or digital assets. By way of example, the third-party administrator may include an escrow agent or a trustee that hold securely the title documentation establishing an ownership of a corresponding, tangible, real-world asset, such as a parcel of real property or the units of gold, by a corresponding owner subject to one or more terms and conditions specified within the elements of agreement data 166.

For example, the elements of asset data 163 associated with the parcel of real property may include, among other things, information documenting a title to, and ownership of, the parcel or real property by user 101, which may be signed by the corresponding owner “in blank” (e.g., digital images of a signed title agreement, etc.). In some instances, the elements of asset data 163 may also specify, for the parcel of real property, a location of the parcel of real property (e.g., a street address, etc.), a size of the parcel of real property, metes and bounds of the parcel of real property, and/or rights and liabilities associated with the parcel of real-property (such as, but not limited to, easement rights that burden, or benefit, the parcel of real-property, restrictive covenants, outstanding or recurring tax liabilities, outstanding or recurring insurance payments, below surface rights, above surface rights, or water rights, etc.).

Further, and in addition to the maintenance of asset data 163 within the corresponding portion of data repository 162, the third-party administrator may also maintain physical copies 176 of the documentation of the owner's title to, and ownership of, a corresponding tangible, real-world asset, such as the parcel of real property owned by user 101, within a corresponding physical storage, such as document vault 174 of FIG. 1. In some instances, access to document vault 174 may not rest solely with the third-party administrator, but may instead be predicted or controlled by registry system 130 (e.g., based an execution of one or more application engines, or elements of executable code recorded onto smart contracts within ledger blocks of a distributed or blockchain ledger, as described herein). For example, document vault 174 include a safe or other secure repository accessible (e.g., a safe-deposit box) accessible via a corresponding alphanumeric code or combination, with registry system 130 may release to a corresponding owner (e.g., via client device 102 or 112) upon an application of one or more of the exemplary redemption or “burning” processes to a ledger-based NFT representative of the corresponding owner's interest in the piece of real property.

The disclosed embodiments are, however, not limited to parcels of real property, and in other instances, the third-party administrator may include an escrow agent or a trustee that not only holds securely the title documentation establishing an ownership of an additional tangible, real-world asset, such as units of gold, a vehicle, or a piece of artwork, but that also possesses physically that additional real-world asset in a secure warehouse, hanger, or other facility, such as a secured third-party storage 170 maintaining real-world asset 172 of FIG. 1. In some instances, and through an application of one or more of the exemplary redemption or “burning” processes to a ledger-based NFT representative of a corresponding owner's interest in the additional tangible, real-world asset (e.g., based on operations performed by registry system 130 and/or TPA system 160), the third-party administrator may release, to the corresponding owner, both the title documentation (e.g., for countersignature by the corresponding owner) and the additional tangible, real-world asset.

In some instances, the elements of agreement data 166 may identify an amount of funds paid by an initial owner of the real-world asset (e.g., user 101) to support the maintenance, insurance, taxes, or the physical possession of the tangible, real-world asset during an agreed-upon temporal interval, such as, but not limited, a one-year period or a two-year period. The elements of agreement data 166 may also include information that obligates that third-party administrator to fund a maintenance (and in some instances, a physically possession) of the tangible, real-world asset, and/or the insurance or taxes associated with the tangible, real-world asset, through a duration of the agreed-upon temporal interval, unless a subsequent owner of the real-world asset elects to redeem or “burn” a corresponding ledger-based NFT prior to the completion of the agreed-upon temporal interval. Upon application one or more of the exemplary redemption or “burning” processes to the corresponding ledger-based NFT representative of a subsequent owner's interest in the tangible, real-world asset, the third-party administrator may release, to the corresponding owner, the title documentation (and in some instances, the additional real-world asset), and TPA system 160 may perform operations that refund, to the initial owner, a balance of the funds dedicated to the maintenance, insurance, taxes, or the physical possession of the tangible, real-world asset subsequent to the burning of the corresponding, ledger-based NFT.

The disclosed embodiments are also not limited to tangible, real-word assets, such as the parcels of real property, units of gold or other precious metals, vehicles, or pieces artwork described herein, and in other instances, the third-party administrator may hold securely title documentation establishing an ownership of a corresponding digital asset, such as a piece of digital artwork or music or an element of property within a metaverse or other digital environment, by a corresponding owner subject to one or more terms and conditions specified within additional elements of elements of agreement data 166. For instance, asset data 163 may include elements of structured or unstructured digital content that identify (and characterize) the corresponding digital asset and that document a title to, and ownership of, the corresponding digital asset by user 101 or user 111. By way of example, the digital asset may correspond to a parcel of digital property within a metaverse, and the corresponding elements of asset data 163 may also specify, for the parcel of digital property, a location of the parcel of the parcel within the metaverse, a size of the parcel of digital property, metes and bounds of the parcel of digital property, and/or rights and liabilities associated with the parcel of real-property, such as outstanding or recurring insurance payments.

In some instances, the elements of agreement data 166 may identify an amount of funds paid by an initial owner of the digital asset (e.g., user 101) to support a maintenance of the digital asset during an agreed-upon temporal interval, such as, but not limited, a one-year period or a two-year period. The elements of agreement data 166 may also include information that obligates that third-party administrator to fund a maintenance of the digital asset through a duration of the agreed-upon temporal interval, unless a subsequent owner of the digital asset elects to redeem or “burn” a corresponding ledger-based NFT prior to the completion of the agreed-upon temporal interval. Upon application one or more of the exemplary redemption or “burning” processes to the corresponding ledger-based NFT representative of a subsequent owner's interest in the digital asset, the third-party administrator may release, to the corresponding owner via TPA system 160, data documenting the title to the digital asset, and TPA system 160 may perform operations that refund, to the initial owner, a balance of the funds dedicated to the maintenance of the digital asset subsequent to the burning of the corresponding, ledger-based NFT.

Referring back to FIG. 1, and to perform any of the exemplary processes described herein, registry system 130 may maintain, within the one or more tangible, non-transitory memories, a data repository 134 that includes, among other things, an NFT data store 136 and a distributed ledger 144. NFT data store 136 may, for example, include information that identifies one or more ledger-based NFTs minted through an implementation of any of the exemplary processes described herein, and in some instances, data characterizing a device that minted the one or more of the ledger-based NFTs (e.g., a public cryptographic key or other wallet address of wallet application 106 executed by client device 102, etc.) and data characterizing a tangible, real-world asset or digital asset. By way of example, the one or more ledger-based NFTs maintained within NFT data store 136 may include, among other things, an NFT 138 representative of a legally valid ownership of a tangible, real-world asset by a corresponding owner, such as an improved parcel of real-property (e.g., that includes a home) owned by user 101, or one or more units of a precious metal, such as gold (e.g., in physical form, such as gold bars or coins).

NFT 138 may, for example, include elements of encrypted data that, upon decryption and subsequent release to user 101 to third-party administrator associated with TPA system 160, may enable user 101 to obtain not only physical or digital documentation of user 101's ownership interest in, and title to, the tangible, real-world asset (e.g., digital images or physical copies of title documents signed by a prior owner of the real-world asset that “minted” NFT 138) but in instances, physical possession of the tangible, real-world asset. By way of example, NFT 138 may include an encrypted, alphanumeric release code of predetermined length or composition (e.g., an encrypted, ten-character alphanumeric release code, etc.). The alphanumeric release code may be encrypted using, among other things, an encryption key associated with registry system 130 (e.g., a private cryptographic key, etc.), and may be decrypted using a corresponding decryption key (e.g., a public cryptographic key), which registry system 130 may provision to client devices 102 and 112 and to TPA system 160 across communications network 120 using any appropriate communications protocol, such as those described herein.

Upon an application of one or more of the exemplary redemption or “burning” processes described herein, to NFT 138, registry system 130 may provision the encrypted, alphanumeric release code across communications network 120 to TPA system 160 (e.g., using any appropriate communications protocol, such as those described herein), which may perform operations that decrypt the encrypted, alphanumeric release code using the corresponding decryption key. Based on the decrypted release code, TPA system 160 may perform operations that prompt the third-party administrator to release one or more physical (or digital) asset or title documents associated with the real-world asset to user 101. In some instances, user 101 may perfect the ownership interest in real-world asset based on a countersignature on the asset or title documents. Further, in some examples, the third-party administrator may also relinquish physical possession of the real-world asset to user 101 in response to the decryption of the encrypted release code.

In some instances, the decrypted release code may correspond to an alphanumeric combination or code that enables user 101 to access a safe or other secure repository accessible (e.g., a safe-deposit box) that maintains the physical copies of title documents associated with the tangible, real world asset, such as, but not limited to, document vault 174. For example, TPA system 160 may perform operations that provide, to registry system 130 across communications network 120, the alphanumeric combination or code, a location of document vault 174, and time periods during which document vault 174 is accessible to owners of the ledger-based NFTs described herein. In some instances, upon generation or minting of NFT 138 using any of the exemplary processes described herein, the third-party administrator may, based on information presented by TPA system 160, place physical copies of the title documents and any associated release instructions associated with the title documents or the real-world asset (e.g., that enable user 101 to obtain the title documents and/or the real-world asset form the third-party administrator) within document vault 174.

Further, and upon an application of one or more of the exemplary redemption or “burning” processes to a ledger-based NFT representative of the user 101's interest in the parcel of real property (or the units of gold, etc.), client device 102 may receive, from registry system 130, an encrypted alphanumeric combination or code to document vault 174, along with encrypted (or unencrypted) information identifying the location of document vault 174, and the time periods during which document vault 174 is accessible to user 101. As described herein, executed wallet application 106 at client device 102 may decrypt the encrypted alphanumeric combination or code, and in some instances, the encrypted information identifying the location and accessible time periods of document vault 174, and may present the new-decrypted a graphical representation of the now-decrypted alphanumeric combination or code and/or information to user 101 within a corresponding digital interface (e.g., via display unit 109A of client device 102). User 101 may proceed to the physical location of document vault 174 during the available time periods, and obtain the physical copies of the title documents and any associated release instructions, which may enable user 101 to perfect the ownership interest in the tangible, real-world asset and in some instances, to obtain physical possession of the tangible, real-world asset from the third-party administrator.

In other examples, upon generation or minting of NFT 138 using any of the exemplary processes described herein, an initial owner of the tangible, real-world asset and third-party administrator may each stake a predetermined quantity of a stablecoin specified within the elements of agreement data 166 (e.g., as pegged to a fiat currency, an exchange-traded commodity, or an additional cryptocurrency, etc.) into a multi-signature NFT vault within digital copies of copies of the title documents and any associated release instructions associated with the title documents or the tangible, real-world asset (not illustrated in FIG. 1). Upon release of the corresponding title documents and any associated release instruction, and in some instances, upon release of the corresponding real-world asset, to user 101 (e.g., upon application of one or more of the exemplary redemption or “burning” processes described herein to NFT 138), user 101 may confirm that the third-party administrator maintained the tangible, real-world asset in accordance with corresponding elements of agreement data 166. Based on the confirmation, registry system 130 may perform any of the exemplary processes described herein to release the stablecoins staked by the third-party administrator to a wallet address (e.g., a public cryptographic key) of a digital wallet maintained on behalf of the third-party administrator by one or more application programs executed by TPA system 160. Certain of these exemplary processes, which release the staked stablecoins to the third-party administrator based on a verified compliance of the third-party administrator with the elements of agreement data 166, may further reduce a counterparty risk of malfeasance or failure of the third-party administrator maintain the real-world asset in accordance with the elements of agreement data 166.

Further, as illustrated in FIG. 1, NFT data store 136 may also include one or more hybrid NFTs, such, but not limited to, hybrid NFT 140 that represents an ownership interest in a tangible, real-world asset, such as those described herein, and further, that data associated with a high-definition and three-dimensional graphical representation of the tangible real-world asset, which may be provable as accurate and transported into, or used within, a metaverse or other digital environment. The high-definition three-dimensional graphical representation may be accurate to a scale of the dimensions of the real-world asset within the metaverse or other digital environment, and may facilitate a simulation of the real-world asset within the metaverse or other digital environment. Further, by way of example, hybrid NFT 140 may be utilized as a metaverse asset, with which user 101 and/or user 111 may interact to display, demonstrate and view a visual representation of a current condition or state of the tangible, real-world asset before entering into a transaction involving hybrid NFT 140.

The metaverse in which hybrid NFT 140 is displayed may be an existing metaverse, or a metaverse environment specifically designed for the transaction of tangible, real-world assets through metaverse assets. Further, in some instances, user 101 and/or user 111 may, via input provided to corresponding ones of client device 102 or 112, initiate transitions involving real-world assets based on interactions with corresponding ones of the metaverse assets within a metaverse or other digital environment. For example, upon minting of hybrid NFT 140 using any of the exemplary processes described herein, an owner (e.g., user 101) may scan visually a real-world asset associated with hybrid NFT 140 using an existing virtual-reality (VR) platform, such as Matterport™, another VR scanning platform, or other similar technologies (e.g., in communication with registry system 130 or client devices 102 and/or 112), and the scan of the real-world asset 198 may be referenced as a hash in the hybrid NFT 140.

Further, client devices 102 and/or 112 may also include additional functionality, such as augmented-reality (AR), VR, or mixed reality technology, which enables user 101 and/or user 111 to view and interact with the scan of the tangible, real-world asset within the metaverse or digital environment (e.g., in high-definition and in three dimension) before initiating a transaction involving hybrid NFT 140. By way of example, executed wallet application 106 at client device 102 may enable user 101 to initiate a purchase of the tangible, real-world asset associated with hybrid NFT 140 (e.g., via input provided to input unit 109B) based on, or in response to, a virtual interaction with the three-dimensional graphical representation of the tangible, real-world asset within a metaverse or other digitally simulated environment. In some instances, a simulation of the tangible, real-world asset within a digital environment may allow user 111 (or user 101, etc.) to more effectively evaluate, experience or test the tangible, real-world asset, such as, but not limited to, an apartment home that may be visually scanned by the user 101 and viewed by the user 111.

Further, NFT data store 136 may also include one or more custody NFTs representative of release instructions associated with title documents of a tangible, real-world asset or digital asset, or with the real-world or digital asset, such as, but not limited to, custody NFT 142 representative of the release instructions for the title documents of the parcel of real property (or the units of gold, etc.) associated with NFT 138, as described herein (e.g., that enable user 101 or user 111 to obtain the title documents from the third-party administrator). By way of example, and upon the minting of NFT 138 using any of the exemplary processes described herein, registry system 130 may generate custody NFT 142 and provision custody NFT 142 to a digital wallet maintained by one or more application programs executed by TPA system 160. In some instances, custody NFT 142 may operate digitally in conjunction with NFT 138 when TPA system 160 transmits custody NFT 142 to a wallet address that is “paired” with NFT 138 (e.g., and associated with “burning” NFT 138).

Referring back to FIG. 1, data repository 134 may also maintain a distributed ledger 144 that include one or more digital or smart contracts 146 and one or more discrete ledger blocks 148. In some instances, the one or more digital contracts 146 may include elements of executable code or other instructions recorded within corresponding elements of distributed ledger 144, and when executed by the one or more processors of registry system 130 (e.g., based on programmatic commands generated by one or more executed application engines), the elements of executable code or other instructions may cause registry system 130 to perform one or more of the exemplary processes described herein to generate or “mint” a ledger-based, non-fungible token (NFT) representative of a legally valid ownership of a corresponding tangible, real-word or digital asset (such as, but not limited to, one or more of NFT 138, hybrid NFT 140, or custody NFT 142), that facilitate exchange-based or peer-to-peer transfer of one or more of the minted NFTs between owners, and that facilitate a redemption or a “burn” of a corresponding one of the minted NFTs (e.g., which releases corresponding title documents and in some instances, the underlying tangible, real-world or digital asset, to a corresponding owner).

Further, the one or more discrete ledger blocks 148 may include data that, for corresponding ones of the exemplary, ledger-based NFTs described herein (e.g., ledger-based NFT 138, hybrid NFT 140, custody NFT 142, etc.), characterize a minting of the corresponding one of the ledger-based NFTs on behalf of an initial owner (e.g., temporal data characterizing a minting time, data characterizing the initial owner, such as a corresponding wallet address, data characterizing the associated tangible, real-world or digital asset, etc.), each subsequent transaction, trade, or exchange involving that corresponding, ledger-based NFT across one or temporal intervals (e.g., transaction data, such as a transaction date or a transaction amount, data characterizing each successive owner, such as a corresponding wallet address, etc.), and the final redemption or burning of the corresponding, ledger-based NFT by a final one of the successive owners, and a release of corresponding title documents (and in some instances, of the real-world or digital asset) to the final one of the successive owners. In some instances, and through a recordation of the data characterizing the minting, the trading, and the eventual burning of corresponding ones of the ledger-based NFTs, (including the hybrid NFTs described herein), ledger blocks 148 of distributed ledger 144 may establish, a cryptographically secure, immutable, auditable record of the corresponding, ledger-based NFTs, and the ownership of the underlying tangible, real-world assets or digital assets (the associated title documentation), across multiple temporal intervals. Further, and as described herein, the recordation within the ledger blocks of the distributed or blockchain ledger of transfer dates and transfer prices characterizing transfers of the corresponding ones of the ledger-based NFTs across multiple temporal intervals may establish, within ledger blocks 148 of distributed ledger 144, a historical registry of NFT transfer prices across the multiple temporal intervals.

Referring back to FIG. 1, and to perform any of the exemplary processes described herein, registry system 130 may maintain, within the one or more tangible, non-transitory memories, an application repository 149 that includes, among other things, a platform engine 150, a registry engine 152, and oracle engine 154, and a fractionalization engine 156. In some instances, and upon execution by the one or more processors of server 132, executed platform engine 150 may perform any of the exemplary processes described herein to generate or “mint” a ledger-based, non-fungible token (NFT) representative of a legally valid ownership of a corresponding tangible, real-word asset or digital asset, such as, but not limited to, one or more of NFT 138, hybrid NFT 140, or custody NFT 142 (e.g., based on an execution of one or more of the elements of executable code or software instructions maintained on distributed ledger 144 within digital contracts 146). By way of example, and as described herein, executed platform engine 150 may perform operations that obtain (i) elements of documentation data that establishes an ownership interest of an initial owner (e.g., user 101 of client device 102, etc.) in a tangible, real-world asset or digital asset subject to an agreement with a trusted, third-party administrator (e.g., elements of agreement data 166), and (ii) elements of asset data subject to the agreement the trusted, third-party administrator (e.g., the elements of asset data 163 maintained at TPA system 160, etc.).

Based on the documentation and asset data, executed platform engine 150 may perform any of the exemplary processes described herein to mint a ledger-based NFT (e.g., ledger based NFT 138 or hybrid NFT 140, etc.), and to store the minted, ledger based NFT within a corresponding portion of an accessible data repository, e.g., a distributed file system. Executed platform engine 150 may also perform operations, described herein, to record an alphanumeric identifier of the minted, ledger-based NFT, temporal data characterizing the minted, ledger-based NFT, a wallet address associated with a minting device, and in some instances, data characterizing the real-world or digital asset, within one or more ledger blocks of a distributed ledger (e.g., within an additional one of ledger blocks 148 of distributed ledger 144). In some instances, executed platform engine 150 may also perform operations, described herein, to provision the ledger-based NFT to the cryptographic wallet address of the minting device (e.g., across communications network 120). For example, the minting device may correspond to client device 102, and an application program executed by client device 102, such as executed wallet application 106, may receive the ledger-based NFT and store the ledger-based NFT within a portion of memory 105 associated with the executed wallet application.

Further, and upon execution by the one or more processors of server 132, executed platform engine 150 may also perform any of the exemplary processes described herein to facilitate a direct or indirect transfer of one or more of the minted, ledger-based NFTs described herein (e.g., e.g., ledger based NFT 138 or hybrid NFT 140, etc.) between a current owner and a successive owner. In some examples, an indirect transfer of a corresponding one of the minted, ledger-based NFTs described herein from a current owner to a successive owner (e.g., a “recipient”) may be facilitated by a certified NFT exchange established by, and associated with, registry system 130, e.g., based on an execution of corresponding elements of executable code or software instructions maintained establishing one or more of ledger-based digital contracts 146. Further, in some examples, the indirect transfer of the corresponding one of the minted, ledger-based NFTs described herein from the current owner to the recipient may also be facilitated by one or more computing systems associated with a third-party NFT exchange unrelated to registry system, which may perform operations that list the corresponding one of the minted, ledger-based NFTs for sale on the third-party NFT exchange based on a request, received from a device operable by the current owner (e.g., as client device 102 operable by user 101). The request may, for example, may include data identifying the current owner (e.g., a wallet address of executed wallet application 106, etc.), pricing data associated with the requested listing (e.g., a requested price, a minimum acceptable price, etc.), and the corresponding one of the minted, ledger-based NFTs (e.g., ledger-based NFT 138 or hybrid NFT 140).

In some instances, one or more of the executable wallet applications described herein, such as wallet application 106 executed by client device 102 and a comparable wallet application executed by client device 102, may perform operations that verify a compliance of user 101 and user 111, respectively, with corresponding know-your-customer (KYC) or anti-money laundering (AML) processes and protocols. In some instances, these KYC and AML-compliant wallet application may, when executed by corresponding ones of client devices 102 and 112, facilitate a direct transfer of the corresponding one of the minted, ledger-based NFTs held within a digital wallet maintained on behalf of user 101 by executed mobile wallet application 106 to an additional digital wallet maintained on behalf of user 101 by an executed mobile wallet application at client device 112. As described herein, and throughout these direct and indirect transfers, the third-party administrator may maintain securely the real-world or digital asset associated with the corresponding one of the minted, ledger-based NFTs in accordance with the elements of agreement data 166, and may submit timely payment for any associated insurances, property taxes and maintenance costs, which are paid up front (on an annual basis, for example) by the initial owner of associated tangible, real-world asset or digital asset.

Executed platform engine 150 may obtain or receive transfer data characterizing an approved, indirect transfer of the corresponding one of the minted, ledger-based NFTs listed on the certified NFT exchange associated with registry system 130, or alternatively, on one of the third-party NFT exchanges unrelated to registry system 130, from user 101 (e.g., the current owner) to user 111 (e.g., the successive owner). In other instances, executed platform engine 150 may obtain or receive additional or alternate elements of transfer data characterizing an approved, direct transfer of the corresponding one of the minted, ledger-based NFTs from the digital wallet maintained on behalf of user 101 by executed wallet application 106 to the additional digital wallet maintained on behalf of user 101 by the wallet application executed by client device 102.

The obtained or received data associated with the approved indirect, or direct, transfer may identify include a wallet address of the current owner (e.g., a public cryptographic key of executed wallet application 106), a wallet address of successive owner (e.g., a public cryptographic key of a wallet application executed by client device 112), elements of transfer data that characterize a transfer time and an agreed-upon transfer price, and in some instances, data identifying the corresponding one of the minted, ledger-based NFTs. To execute the agreed-upon indirect transfer, executed platform engine 150 may perform any of the exemplary processes described herein to record, within an additional one of ledger blocks 148, portions of the data identifying the corresponding one of the minted, ledger-based NFTs subject to direct, or indirect, transfer, portions of the transfer data (including an alphanumeric identifier of the corresponding, ledger-based NFT, the transfer time and price, etc.), and the wallet addresses of the current owner (e.g., user 101) and the recipient (e.g., user 111). Further, executed platform engine 150 may also perform operations, described herein, provision the corresponding one of the transferred ledger-based NFTs to the wallet address of the recipient, e.g., the public cryptographic key of the wallet application executed by client device 112.

Additionally, and upon execution by the one or more processors of registry system 130, executed platform engine 150 may perform operations that facilitate a redemption or a “burn” of a corresponding one of the minted or transferred ledger-based NFTs (e.g., ledger-based NFT 138, hybrid NFT 140, etc.), which releases title documents confirming ownership of a tangible, real-world asset or a digital asset to a current owner of the corresponding minted or transferred ledger-based NFT and in some instances, provisions the tangible, real-world asset or the digital asset to the current owner. By way of example, and based on a request received from a device operable by a current owner of ledger-based NFT (e.g., generated by executed wallet application 106 of client device 102, etc.), executed platform engine 150 may perform operations, described herein, that verify an interest of the current owner in the ledger-based NFT (e.g., based on data recorded within ledger blocks 148 of distributed ledger 144, which includes an alphanumeric identifier of the ledger-based NFT, etc.) and that confirm the ledger-based NFT is available for redemption or burning (e.g., that the ledger-based NFT is not referenced by a corresponding list of unavailable NFTs, such as one or more stolen or hacked NFTs, maintained by registry system 130).

In some instances, described herein, executed platform engine 150 may perform operations that approve the request to burn the ledger-based NFT based on the verified ownership interest of the current owner and based on the confirmed availability of the ledger-based NFT, and may perform operations that generate a hash value (e.g., a “burn hash”) based on, and representative of, at least a portion of the ledger-based NFT available for burning. For example, executed platform engine 150 may generate the burn hash based on an application of a corresponding hash algorithm or process to the portion of the ledger-based NFT, and examples of the hash algorithms or processes includes a SHA-2 process, a SHA-3 process, or a BLAKE algorithm. As described herein, executed platform engine 150 may perform any of the exemplary processes described herein to record the burn hash associated with the now-burned ledger-based NFT within an additional ledger block of distributed ledger 144, along with temporal data characterizing a time or date of the burning of the ledger-based NFT, data identifying and characterizing the current owner (e.g., a wallet address of executed wallet application 106), and/or data identifying the ledger based NFT (e.g., the alphanumeric identifier) or the associated real-world or digital asset.

Further, and as described herein, executed platform engine 150 may perform operations the provision the encrypted release code maintained within the now-burned ledger-based NFT across communications network 120 to a computing system of a corresponding third-party administration, such as TPA system 160. In some instances, described herein, TPA system 160 may decrypt the encrypted release code, and based on the decrypted release code, the third-party administrator may release one or more physical (or digital) title documents associated with the tangible, real-world asset or the digital asset to the current owner, and the current owner may perfect the ownership interest in the tangible, real-world asset (e.g., based on a countersignature on the asset or title documents) or in the digital asset. The third-party administrator may relinquish physical possession of the real-world asset. Additionally, or alternatively, executed platform engine 150 may perform operations that provision, to a device of a the current owner (e.g., client device 102 of user 101), a digital release code that enables the current owner to access a secure, physical storage unit (e.g., document vault 174 of FIG. 1) and obtain the one or more title documents (e.g., the physical copies 176) associated with the tangible, real-world asset (and in some instances the real-world asset). In other instances, described herein, executed platform engine 150 may also perform operations that cause registry system 130 to release the digital asset associated with the now-burned ledger-based NFT (e.g., a metaverse asset), and to provision the digital asset to a device operable by the current owner (e.g., client device 102 of user 101) across communications network 120.

In some examples, one or more of the ledger-based NFTs described herein (e.g., ledger based NFT 138, hybrid NFT 140, etc.) may include a non-changeable hyperlink that, when accessed by a current owner via a device (e.g., user 101 of client device 102), causes the device to transmit, to registry system 130 across communications network 120, a request for data characterizing a corresponding one of the ledger-based NFTs and the associated tangible, real-world asset (e.g., parcels of real estate, units of gold or other precious metals, etc.) or digital asset across one or more temporal intervals. By way of example, user 101 may access ledger-based NFT 138, which is representative of a legally valid ownership of a parcel of real estate (e.g., a real-world asset), via executed mobile wallet application 106, and may provide input to client device 102 (e.g., via input unit 109B) that selects a non-changeable hyperlink within ledger-based NFT 138. Based on the provisioned input, executed wallet application 106 may generate a request for aggregated data characterizing ledger-based NFT 138 and/or the parcel of real estate across one or more temporal intervals, and client device 102 may transmit the generated request across communications network 120 to client device 102.

In some instances, registry system 130 may receive the request, and upon execution by the one or more processors of server 132, executed registry engine 152 may perform operations that obtain, from the received request, data identifying the ledger-based NFT 138 and/or the parcel of real estate, and that generate the aggregated data characterizing ledger-based NFT 138 and/or the parcel of real estate across the one or more temporal intervals. The aggregate data may include, but is not limited to, all prior trade prices (with Oracle Data Safe™ feeds from a certified NFT marketplace associated with registry system 130 or from other, third-party NFT marketplaces), a legal description of the parcel of real estate, a legal description of the real world asset, non-changeable pictures of parcel of real estate, and in some instances, redacted title and other ownership and information documents, the third-party administrator's TPA history of funding, and maintenance amounts spent (i.e. taxes paid, homeowners association (HOA) payments, amount within account, “replenishment,” or “NFT extension payments date”), appraisals, a property inspection report (e.g., as updated and provisioned by TPA system 160), and/or a link to a three-dimensional virtual-reality assets in a metaverse or other digital environment. Executed registry engine 152 may perform operations that provision the elements of aggregated data across communications network 120 to client device 102, and based on a receipt of the aggregated data, executed wallet application 106 may programmatically trigger an execution of web browser 108, which may render portions of the aggregated data within one or more screens of a “certified” and inviolate protected information website page (e.g., via display unit 109A).

Referring back to FIG. 1, and upon execution by the one or more processors of server 132, executed oracle engine 154 may perform operations that establish, for participants in a NFT-based lending process, a trusted “value of collateral” associated with ownership interests in the tangible, real-world assets or digital assets represented by corresponding ones of the ledger-based NFTs described herein. By way of example, and to provide the trusted value of collateral for a parcel of real estate associated with a corresponding one of the ledger-based NFTs, executed oracle engine 154 may perform operations that access a third-party data feed associated with one or more real estate sales and valuation platforms (e.g., Zillow™, Realtor.com™, etc.), and based on data characterizing sales or estimated values of parcels of real-estate having similar type, size, or location, executed oracle engine 154 may perform operations that determine a “comparable parcel price index” for the parcel of real estate (e.g., based on an application of a trained artificial intelligence or machine learning process to data characterizing the parcel of real estate and the similar properties).

Executed oracle engine 154 may provision the “comparable parcel price index” for the parcel of real estate to a computing system associated with the NFT-based lending process (e.g., across communications network 120, etc.), which may determine, for a borrower that staked the corresponding ledger-based NFT as collateral for a loan, the “comparable parcel price index” for the parcel of real estate results in a collateral impairment that triggers, among other things, an obligation by the borrower to either provide additional collateral (using NFTs other crypto or other assets) or repay the loan in whole or part to avoid a default and foreclosure on the NFT collateral. In some instances, certain of the exemplary processes enable the borrow to “override” the “comparable parcel price index” for the parcel of real estate based on a submission of a qualified recent appraisal of the parcel of real estate.

Further, and upon execution by the one or more processors of server 132, executed fractionalization engine 156 may perform operations that enable a current owner of a ledger-based NFT, which represents a 100% ownership of a real-world or digital asset, to fractionalize the ledger-based NFT and generate fractional NFTs that legally represent a corresponding percentage ownership interests in the ledger-based NFT. For example, and based on a request received from a device of the current owner (e.g., from client device 102 of user 101 across communications network 120), executed fractionalization engine 156 may perform operations that stake the ledger-based NFT and freeze and transfer of the ledger-based NFT to successive owners. Further, and based on input received from the current owner (e.g., from device 102 across communications network 120), executed fractionalization engine 156 may establish a user-specific number of the fractional NFTs that legally represent a corresponding percentage ownership interests in the ledger-based NFT (e.g., ten, 100, etc.), and establish voting, notification, or other governance rights of each of the fractional NFTs with respect to corresponding ones of the management, sale, capital calls (e.g., for management of real-world assets, etc.), or other economic, management, or governance features of the combined total of the fractional NFTs. Additionally, in some instances, executed fractionalization engine 156 may also generate a “managing” fractional NFT, which represents a legal right of the current owner to control of manage the ledger-based NFT, including capital calls or any proposed sale or other voting/management relating to the ledger-based NFT.

Executed fractionalization engine 156 may perform operations that provision each of the fractional NFTs to a wallet address of the current owner (e.g., a wallet address of executed wallet application 106 of client device 102 across communications network 120) and further, may perform any of the exemplary processes described herein to record data characterizing the generation of each of the fractional NFTs, and the established voting, notification, or other governance rights, within additional ones of ledger blocks 148 of distributed ledger 144. In some instances, the current owner may post one or more of the fractional NFTs as collateral for a loan, or may elect to transfer one or more of the fractional NFTs to successive owners, e.g., using any of the exemplary processes described herein.

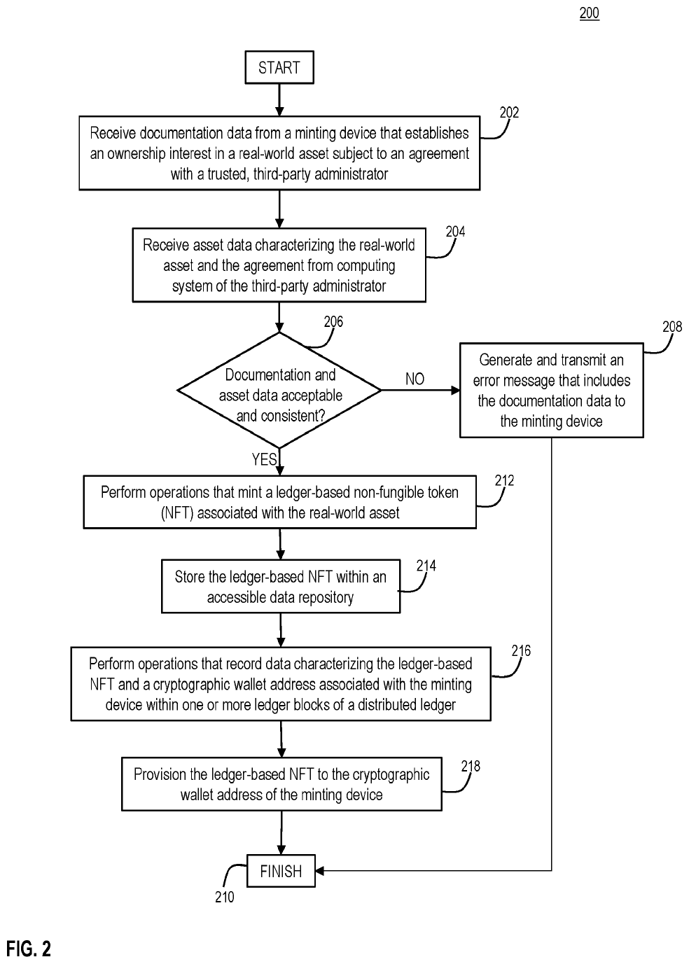

FIG. 2 is a flowchart of an exemplary process 200 for minting a ledger-based, non-fungible token (NFT) representative of a legally valid ownership of a tangible, real-world asset or a digital asset, in accordance with some exemplary embodiments. In some instances, registry system 130 may perform one or more of the steps of exemplary process 200, as described herein. Referring to FIG. 2, registry system 130 may receive documentation data from a minting device (e.g., one of client devices 102 or 112) that establishes an ownership interest of a current owner in a tangible, real-world asset or digital asset subject to an agreement with a trusted, third-party administrator (e.g., in step 202 of FIG. 2).

For example, the documentation data may include, among other things, an physical address of a tangible, real-world asset, a size of the real-world asset, a description of the metes and bounds of the real-world asset, associated rights and liabilities with the real-world asset (such as easement rights that burden the real world asset, easement rights that benefit the real world asset, restrictive covenants, outstanding or recurring tax liabilities, outstanding or recurring insurance payments, below surface rights, above surface rights, and water rights associated with the real world asset), a legal description of the real-world asset, a non-modifiable pictures of the real-world asset, a redacted title and other ownership information documents, and/or a hyperlink to a three-dimensional, virtual-reality representation of the real-world asset within a corresponding metaverse or digital environment. The documentation data may also include, among other things, elements of structured or unstructured digital content that identify (and characterize) the corresponding digital asset and that document a title to, and ownership of, the corresponding digital asset, such as, but not limited to, a location of a parcel of digital property within a corresponding metaverse or digital environment, a size of the parcel of digital property, metes and bounds of the parcel of digital property, and/or rights and liabilities associated with the parcel of digital property, such as outstanding or recurring insurance payments.

Registry system 130 may also receive asset or agreement data associated with the tangible, real-world asset, or the digital asset, from a computing system operable by the third-party administrator, such as TPA system 160 (e.g., in step 204 of FIG. 2). For example, registry system 130 may receive one or more of the exemplary elements of asset data 163 and agreement data 166 described herein, such as, but no limited to, data identifying and characterizing the tangible, real-world asset or the digital asset, data identifying and characterizing funds paid by the current owner of the tangible, real-world asset or the digital asset to facilitate a maintenance of the tangible, real-world asset or the digital asset, taxes or insurance on the tangible, real-world asset or the digital asset, data characterizing appraisals of the tangible, real-world asset or digital asset, and/or inspection reports associated with the tangible, real-world asset or the digital asset.

Registry system 130 may also determine whether the documentation data that establishes the ownership interest in the tangible, real-world asset or the digital asset, and the corresponding elements of asset and agreement data, are acceptable and mutually consistent (e.g., in step 206 of FIG. 2). If, for example, registry system 130 were to determine that the elements of documentation data and the elements of asset and agreement data are not acceptable, or that an inconsistency exists between the elements of documentation data and the elements of asset and agreement data (e.g., step 206; NO), registry system 130 may decline to mint the ledger-based NFT, and may generate and transmit an error message that includes the documentation data to the minting device (e.g., in step 208). Exemplary process 200 is then complete in step 210.

Alternatively, if registry system 130 were to determine that the elements of the documentation data and the elements of the asset and agreement data are acceptable and mutually consistent (e.g., step 206; YES), registry system 130 may perform any of the exemplary processes described herein to mint the ledger-based NFT representative of the legally valid ownership of the tangible, real-world asset or the digital asset by the current owner (e.g., in step 212 of FIG. 2) and to store the newly minted, ledger-based NFT within a corresponding portion of an accessible data repository, such as, but not limited to, NFT data store 136 of data repository 134 (e.g., in step 214 of FIG. 2). Registry system 130 may also perform any of the exemplary processes described herein to record an alphanumeric identifier of the newly minted, ledger-based NFT, temporal data characterizing the newly minted, ledger-based NFT, a wallet address associated with the minting device (e.g., the wallet address of executed wallet application 106 of client device 102, etc.), and in some instances, data characterizing the newly minted, ledger-based NFT and/or the tangible, real-world or digital asset, within one or more ledger blocks of a distributed ledger, such as an additional one of ledger blocks 148 of distributed ledger 144 (e.g., in step 216 of FIG. 2).

For example, in step 216, registry system 130 may broadcast, across communications network 120, the temporal data, the wallet address, and portions of the data characterizing the newly minted, ledger-based NFT and/or the tangible, real-world or digital asset to one or more additional computing systems. As described herein, registry system 130 and the one or more additional computing systems may collectively form a portion of a distributed-ledger network, and each of registry system 130 and the one or more additional computing systems may maintain a local version of distributed ledger 144 within a corresponding tangible, non-transitory memory. In some instances, one or more of registry system 130 and the additional computing systems may perform consensus-based operations that record the alphanumeric identifier, the temporal data, the wallet address, and portions of the data characterizing the newly minted, ledger-based NFT and/or the tangible, real-world or digital asset within the additional one of ledger blocks 148 (e.g., based on a computed proof-of-work or proof-of-stake, etc.), which may establish an “updated” version of distributed ledger 144.

In some instances, the one or more of registry system 130 and the additional computing system may broadcast the updated version of distributed ledger 144 across communications network 120 to the other components of the distributed-ledger network. In other instances, registry system 130 (or a corresponding one of the additional computing systems) may perform operations that record the alphanumeric identifier temporal data, the wallet address, and portions of the data characterizing the newly minted, ledger-based NFT and/or the tangible, real-world or digital asset within the additional one of ledger blocks 148 directly and without consensus-based processing, and may broadcast the updated version of distributed ledger 144 across communications network 120 to the other components of the distributed-ledger network.

In some instances, registry system 130 may also perform operations, described herein, to provision, across communications network 120, the newly minted ledger-based NFT to the cryptographic wallet address of the minting device (e.g., in step 218 of FIG. 2). For example, the minting device may correspond to client device 102, and an application program executed by client device 102, such as executed wallet application 106, may receive the ledger-based NFT and store the ledger-based NFT within a portion of memory 105 associated with the executed wallet application. Exemplary process 200 is then complete in step 210.

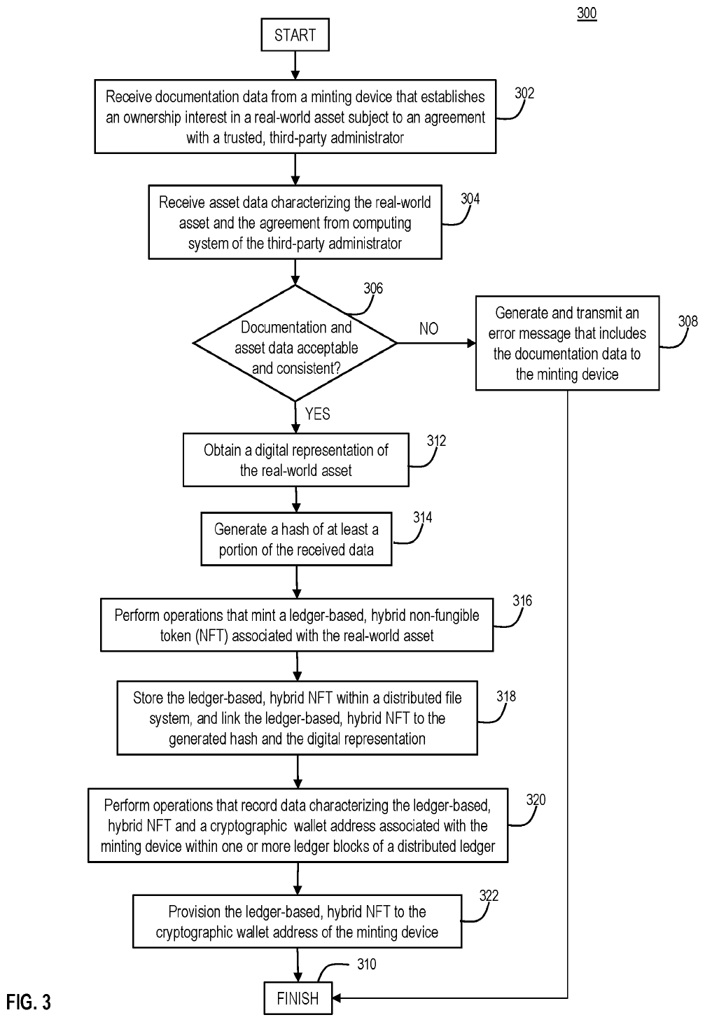

FIG. 3 is a flowchart of an exemplary process 300 for minting a ledger-based, hybrid non-fungible token (NFT) representative of both a legally valid ownership of a real-world asset by a current owner and a graphical representation of the real-world asset capable of transportation into, or use within, a metaverse or other digital environment, in accordance with some exemplary embodiments. In some instances, registry system 130 may perform one or more of the steps of exemplary process 300, as described herein. Referring to FIG. 3, registry system 130 may receive documentation data from a minting device (e.g., one of client devices 102 or 112) that establishes an ownership interest of a current owner in a tangible, real-world asset subject to an agreement with a trusted, third-party administrator (e.g., in step 302 of FIG. 3). For example, the documentation data may include, among other things, an physical address of the tangible, real-world asset, a size of the tangible, real-world asset, a description of the metes and bounds of the tangible, real-world asset, associated rights and liabilities with the tangible, real-world asset (such as easement rights that burden the real world asset, easement rights that benefit the tangible, real-world asset, restrictive covenants, outstanding or recurring tax liabilities, outstanding or recurring insurance payments, below surface rights, above surface rights, and water rights associated with the tangible, real-world asset), a legal description of the tangible, real-world asset, a non-modifiable pictures of the tangible, real-world asset, a redacted title and other ownership information documents, and/or a hyperlink to a three-dimensional, virtual-reality representation of the tangible, real-world asset within a corresponding metaverse or digital environment.

Registry system 130 may also receive asset or agreement data associated with the real-world asset across communications network 120 from a computing system operations by the third-party administrator, such as TPA system 160 (e.g., in step 304 of FIG. 3). For example, the registry system 130 may one or more of the exemplary elements of asset data 163 and agreement data 166 described herein, such as, but no limited to, data identifying and characterizing the tangible, real-world asset and funds paid by the current owner of the tangible, real-world asset to facilitate a maintenance of the tangible, real-world asset, taxes or insurance on the tangible, real-world asset, data characterizing appraisals of the tangible, real-world asset, and/or property inspection reports associated with the real-world asset. Registry system 130 may also determine whether the documentation data that establishes the ownership interest in the tangible, real-world asset and the asset and agreement data associated with the tangible, real-world asset are acceptable and mutually consistent (e.g., in step 306 of FIG. 3). If, for example, registry system 130 were to determine that the elements of documentation data and the elements of asset and agreement data are not acceptable, or that an inconsistency exists between the elements of documentation data and the elements of asset and agreement data (e.g., step 206; NO), registry system 130 may decline to mint the ledger-based NFT, and may generate and transmit an error message that includes the documentation data to the minting device (e.g., in step 308 of FIG. 3). Exemplary process 300 is then complete in step 310.

Alternatively, if registry system 130 were to determine that the elements of the documentation data and the elements of the asset and agreement data are acceptable and mutually consistent (e.g., step 306; YES), registry system 130 may perform any of the exemplary processes described herein to obtain a digital representation of the real-world asset (e.g., in step 312 of FIG. 3). The graphical representation may, for example, include a high-definition, three-dimensional graphical representation of the tangible, real-world asset, which may be provable as accurate and transported into, or used within, a metaverse or other digital environment. The high-definition, three-dimensional graphical representation may be accurate to a scale of the dimensions of the tangible, real-world asset within the metaverse or other digital environment, and may facilitate a simulation of the real-world asset within the metaverse or other digital environment. In some instances, an existing virtual-reality (VR) platform, such as Matterport™, another VR scanning platform or other similar technologies, may scan the real-world asset, generate the graphical representation, and provision the generated graphical representation to registry system 130, e.g., directly across communications network 120 or from one or more of the minting device or TPA system 160.

Registry system 130 may also perform operations, described herein, to compute a hash representative of, and based on, at least a portion of the received digital representation (e.g., in step 314 of FIG. 3). For example, registry system 130 may generate the hash based on an application of a corresponding hash algorithm or process to at least the portion of the received digital representation, and examples of the hash algorithms or processes includes a SHA-2 process, a SHA-3 process, or a BLAKE algorithm.

Registry system 130 may also perform any of the exemplary processes described herein to mint the ledger-based hybrid NFT representative of the legally valid ownership of the real-world asset by the current owner and the graphical representation of the real-world asset (e.g., in step 316 of FIG. 3), and to store the newly minted, ledger-based hybrid NFT within a corresponding portion of an accessible data repository, such as, but not limited to, NFT data store 136 of data repository 134 (e.g., in step 318 of FIG. 2). As described herein, the newly minted, ledger-based hybrid NFT may include the generated hash of the graphical representation (and as such, may reference the graphical representation of the real-world asset). Further, in some instances, registry system 130 may also perform operations that associate, or link together the newly minted, ledger-based hybrid NFT, the generated hash, and the graphical representation of the real-world asset within the accessible data repository, e.g., by generating a corresponding hyperlink, which may be incorporated within the newly minted, ledger-based hybrid NFT.

Registry system 130 may also perform any of the exemplary processes described herein to record temporal data characterizing the newly minted, ledger-based hybrid NFT, a wallet address associated with the minting device (e.g., the wallet address of executed wallet application 106 of client device 102, etc.), and in some instances, data characterizing the newly minted, ledger-based hybrid NFT (e.g., a corresponding alphanumeric identifier) and/or the tangible, real-world asset, within one or more ledger blocks of a distributed ledger, such as an additional one of ledger blocks 148 of distributed ledger 144 (e.g., in step 320 of FIG. 3).

For example, in step 320, registry system 130 may broadcast, across communications network 120, the temporal data, the wallet address, and portions of the data characterizing the newly minted, ledger-based hybrid NFT and/or the tangible, real-world asset to one or more additional computing systems. As described herein, registry system 130 and the one or more additional computing systems may collectively form a portion of a distributed-ledger network, and each of registry system 130 and the one or more additional computing systems may maintain a local version of distributed ledger 144 within a corresponding tangible, non-transitory memory. In some instances, one or more of registry system 130 and the additional computing systems may perform consensus-based operations that record the temporal data, the wallet address, and portions of the data characterizing the newly minted, ledger-based hybrid NFT (e.g., an alphanumeric identifier) and/or the tangible, real-world asset within the additional one of ledger blocks 148 (e.g., based on a computed proof-of-work or proof-of-stake, etc.), which may establish an “updated” version of distributed ledger 144.

The one or more of registry system 130 and the additional computing systems may broadcast the updated version of distributed ledger 144 across communications network 120 to the other components of the distributed-ledger network. In other instances, registry system 130 (or a corresponding one of the additional computing systems) may perform operations that record the temporal data, the wallet address, and portions of the data characterizing the newly minted, ledger-based hybrid NFT (e.g., a corresponding alphanumeric identifier) and/or the tangible, real-world asset within the additional one of ledger blocks 148 directly and without consensus-based processing, and may broadcast the updated version of distributed ledger 144 across communications network 120 to the other components of the distributed-ledger network.

In some instances, registry system 130 may also perform operations, described herein, to provision, across communications network 120, the newly minted ledger-based hybrid NFT to the cryptographic wallet address of the minting device (e.g., in step 322 of FIG. 3). For example, the minting device may correspond to client device 102, and an application program executed by client device 102, such as executed wallet application 106, may receive the ledger-based hybrid NFT and store the ledger-based hybrid NFT within a portion of memory 105 associated with the executed wallet application. Exemplary process 300 is then complete in step 310.

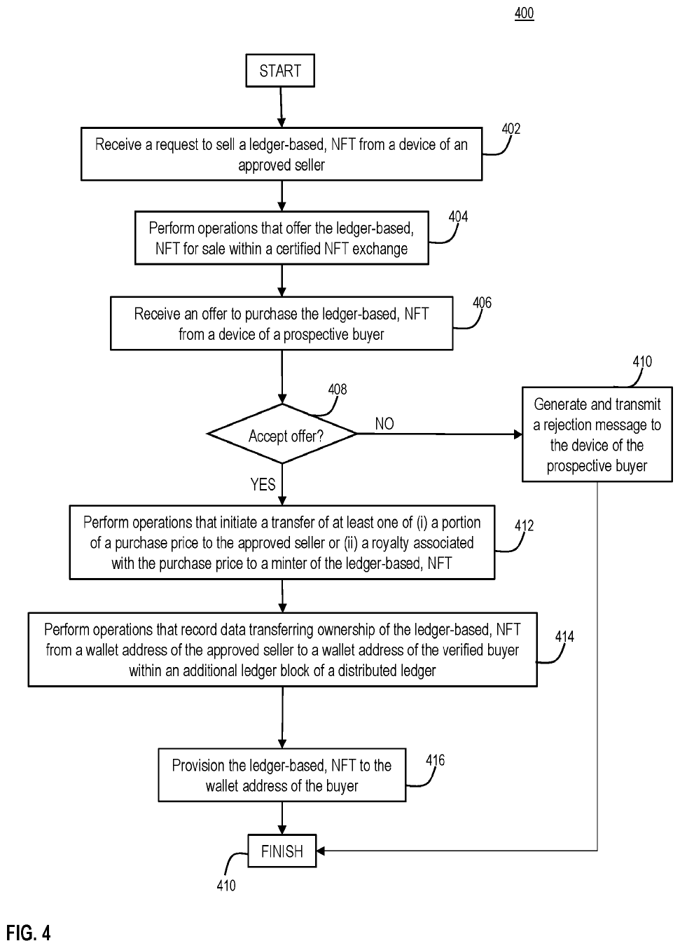

FIG. 4 is a flowchart of an exemplary process 400 for transferring indirectly ownership of ledger-based non-fungible tokens (NFTs) using a certified NFT exchange, in accordance with some exemplary embodiments. In some instances, registry system 130 may perform one or more of the steps of exemplary process 400, as described herein. Referring to FIG. 4, registry system 130 may receive a request to transfer an ownership of a ledger-based NFT from a device operable by a current owner of the ledger-based NFT (e.g., in step 402 of FIG. 4). In some instances, the ledger-based NFT may be representative of a legally valid ownership of a tangible, real-world asset or a digital asset by the current owner, and in other instances, the ledger-based NFT may include a hybrid NFT representative of both a legally valid ownership of a tangible, real-world asset by the current owner and a graphical representation of the tangible, real-world asset capable of transportation into, or use within, a metaverse or other digital environment.

In some instances, the current owner (e.g., user 101 associated with client device 102) may represent a minter of the ledger-based NFT (e.g., that requested registry system 130 mint the ledger-based NFT using any of the exemplary processes described herein), or a successive owner of the ledger-based NFT (e.g., that receive the NFT via an indirect or direct transfer, as described herein). Further, the certified NFT exchange may be associated with registry system 130, and the current owner, e.g., user 101, may be approved by registry system 130 to list the ledger-based NFT for transfer via the certified NFT exchange (e.g., user 101 is not associated with prior fraudulent transactions, is not in default of any taxes or other dues on a tangible, real world asset or a digital asset corresponding to the ledger-based NFT, etc.).

The received request may, for example, include data identifying the ledger-based NFT and element of pricing data, such as, but not limited to, a specified sales price and/or a reserve price, and registry system 130 may perform any of the exemplary processes described herein to list the ledger-based NFT for sale on the certified NFT exchange in accordance with the elements of pricing data (e.g., in step 404 of FIG. 4). Registry system 130 may also receive, from a device of a prospective buyer, an offer to purchase the listed, ledger-based NFT at a specified purchase price (e.g., in step 406 of FIG. 4). In some instances, the prospective buyer may include user 111, and registry system 130 may receive the offer from client device 112 across communications network 120. Further, in some instances, user 111 may corresponding to an approved buyer that complies with one or more imposed know-your-customer (KYC) or anti-money laundering (AML) processes and additionally, or alternatively, that possess funds (e.g., fiat currencies, cryptocurrency, etc.) sufficient to fund not only the purchase price of the ledger-based NFT, but also a portion of the prepayment of the maintenance fees associated with the ledger-based NFT (e.g., as specified within the elements of agreement data 166 maintained at TPA system 160) and/or additional surcharges associated with the application of the KYC or AML processes to the respective buyer by registry system 130.

In some instances, registry system 130 may perform operations that determine whether to accept the offer to purchase the ledger-based NFT in accordance with the specified purchase price (e.g., in step 408 of FIG. 4). For example, registry system 130 may perform operations in step 408 that accept the offer when the purchase price offered by the prospective buyer exceeds the reserve price of specified by the approved seller and further, whether the offered purchase price exceeds purchase prices offered by other prospective buyers. In other example, the offer may represent a “buy now” offer, and registry system 130 may perform operations in step 408 that accept the offer when the purchase price offered by the prospective buyer exceeds the reserve price and is equivalent to, or exceeds the sales price specified by the approved seller in the received request. If, for example, registry system 130 were to decline the prospective buyer's offer to purchase the ledger-based NFT (e.g., step 408; NO), registry system 130 may perform operations that generates and transmits a rejection message to the device of the prospective buyer (e.g., in step 410 of FIG. 4). Exemplary process 400 is then complete in step 410.

If, for example, registry system 130 were to accept the prospective buyer's offer to purchase the ledger-based NFT (e.g., step 408; YES), registry system 130 may receive payment data indicative of an initiated or received payment by the prospective buyer for the ledger-based NFT (e.g., in step 412 of FIG. 4). In some instances, a payment amount of the initiated or received payment may reflect the accepted purchase price of the ledger-based NFT (e.g., in units of fiat currency and/or cryptocurrencies), and a specified portion of the prepayment of the maintenance fees associated with the ledger-based NFT (e.g., as specified within the elements of agreement data 166 maintained at TPA system 160), and registry system 130 may perform operations that request, and receive, all or a selected portion of the payment data across communications network 120 from TPA system 160. Further, in some instances, the payment amount of the initiated or received payment may reflect additional surcharges associated with the application of the KYC or AML processes to the respective buyer by registry system 130, and registry system 130 may maintain at least a portion of an accessible data repository, such as data repository 134 maintained within the one or more tangible memories of registry system 130. Registry system 130 may also perform operations that initiate a transfer of (i) funds consistent with a portion of the purchase price to the approved seller or (ii) funds consistent with a royalty on the purchased ledger-based NFT to a minter of the ledger-based NFT (e.g., also in step 412 of FIG. 4). By way of example, the royalty may reflect all, or a selected portion, of the prepaid maintenance fees associated with the ledger-based NFT, as described herein.

Registry system 130 may also perform operations that record data transferring ownership of the ledger-based, NFT from a wallet address of the approved seller to a wallet address of the buyer within an additional ledger block of a distributed ledger, such as an additional one of ledger blocks 148 of distributed ledger 144 (e.g., in step 414 of FIG. 4). In some instances, the recorded data may include, among other things, an alphanumeric identifier of the ledger-based NFT, a wallet address of the approved seller (e.g., a wallet address of executed wallet application 106 at client device 102), a wallet address of the buyer (e.g., a wallet address of an wallet application executed by client device 102), information identifying the ledger-based, NFT, and transfer data, such as a transfer date and a purchase price.

For example, in step 414, registry system 130 may broadcast, across communications network 120, portions of the data transferring ownership of the ledger-based, NFT from a wallet address of the approved seller to a wallet address of the buyer to one or more additional computing systems. As described herein, registry system 130 and the one or more additional computing systems may collectively form a portion of a distributed-ledger network, and each of registry system 130 and the one or more additional computing systems may maintain a local version of distributed ledger 144 within a corresponding tangible, non-transitory memory. In some instances, one or more of registry system 130 and the additional computing systems may perform consensus-based operations that record the portions of the data transferring ownership of the ledger-based, NFT from a wallet address of the approved seller to a wallet address of the buyer within the additional one of ledger blocks 148 (e.g., based on a computed proof-of-work or proof-of-stake, etc.), which may establish an “updated” version of distributed ledger 144.

The one or more of registry system 130 and the additional computing systems may broadcast the updated version of distributed ledger 144 across communications network 120 to the other components of the distributed-ledger network. In other instances, registry system 130 (or a corresponding one of the additional computing systems) may perform operations that record the portions of the data transferring ownership of the ledger-based, NFT from a wallet address of the approved seller to a wallet address of the buyer within the additional one of ledger blocks 148 directly and without consensus-based processing, and may broadcast the updated version of distributed ledger 144 across communications network 120 to the other components of the distributed-ledger network.

Further, registry system 130 may perform operations, described herein, to provision, across communications network 120, the ledger-based NFT to the wallet address of the device of the buyer (e.g., in step 416 of FIG. 4). For example, the device of the buyer may correspond to client device 112, and an application program executed by client device 102, such as an executed wallet application, may receive the ledger-based NFT and store the ledger-based NFT within a portion of memory associated with the executed wallet application. Exemplary process 500 is then complete in step 511.

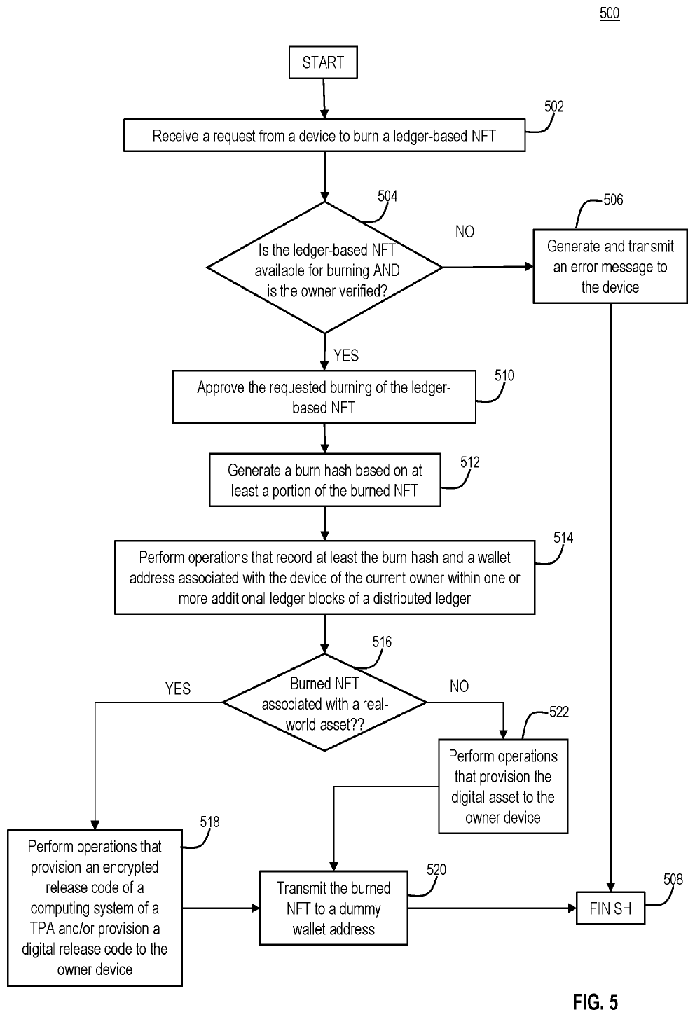

FIG. 5 is a flowchart of an exemplary process 500 for redeeming, or “burning,” a ledger-based non-fungible token (NFT), in accordance with some exemplary embodiments. In some instances, registry system 130 may perform one or more of the steps of exemplary process 500, as described herein. Referring to FIG. 5, registry system 130 may receive, across communications network 120, a request to redeem, or “burn” a ledger-based NFT from a device operable by a current owner of the ledger-based NFT (e.g., in step 502 of FIG. 5). In some instances, the ledger-based NFT may be representative of a legally valid ownership of a tangible, real-world or digital asset by the current owner, and in other instances, the ledger-based NFT may include a hybrid NFT representative of both a legally valid ownership of a tangible, real-world asset by the current owner and a graphical representation of the tangible, real-world asset capable of transportation into, or use within, a metaverse or other digital environment.

In some instances, the current owner of the ledger-based NFT may include user 101, and executed wallet application 106 may generate the request based on input provided to client device 102 by user 101 (e.g., via input unit 109B). The request may, for example, include the ledger-based NFT, and upon application of the exemplary processes described herein to the ledger-based NFT, which redeem or burn the ledger-based NFT, a computing system associated with a third-party administrator, such as TPA system 160, may perform operations that prompt the third-party administrator to release title documents confirming ownership of the tangible, real-world asset to the owner of the now-burned ledger-based NFT and in some instances, provisions the tangible, real-world asset to the current owner, e.g., across communications network 120 to a device operable by the current owner. Additionally, and upon application of the exemplary processes described herein to the ledger-based NFT, registry system 130 may also perform operations that to release a digital asset associated with the now-burned ledger-based NFT to the current owner (e.g., a metaverse asset), and that provision the released digital asset to a device operable by the current owner, e.g., across communications network 120.

Referring back to FIG. 5, registry system 130 perform operations, described herein, that verify an interest of the current owner in the ledger-based NFT and confirm the ledger-based NFT is available for redemption and burning (e.g., in step 504 of FIG. 5). For example, registry system 130 may perform operations that verify the interest of the current owner in the ledger-based NFT based on ownership data recorded within ledger blocks 148 of distributed ledger 144 (which may include an alphanumeric identifier of the ledger-based NFT), and that confirm the ledger-based NFT is available for redemption and burning based on a determination that ledger-based NFT is not referenced within a corresponding list of unavailable NFTs, such as, but not limited to, one or more stolen or hacked NFTs (e.g., maintained by registry system 130). If, for example, registry system 130 were to fail to verify the interest of the current owner in the ledger-based NFT, or to fail to confirm the ledger-based NFT is available for redemption or burning (e.g., step 504; NO), registry system 130 may generate, and transmit across communications network 120, an error message to the device operable by the current owner of the ledger-based NFT (e.g., in step 506 of FIG. 5). Exemplary process 500 is then complete in step 508.

Alternatively, if registry system 130 were to verify the interest of the current owner in the ledger-based NFT, and confirm the ledger-based NFT is available for redemption and burning (e.g., step 504; YES), registry system 130 may approve the requested redemption and burning of the ledger-based NFT (e.g., in step 510 of FIG. 5), and perform operations that generate a hash value (e.g., a “burn hash”) based on, and representative of, at least a portion of the ledger-based NFT (e.g., in step 512 of FIG. 5). For example, registry system 130 may generate the burn hash based on an application of a corresponding hash algorithm or process to at least the portion of the ledger-based NFT, and examples of the hash algorithms or processes includes a SHA-2 process, a SHA-3 process, or a BLAKE algorithm.

Registry system 130 may also perform any of the exemplary processes described herein to record the burn hash associated with the now-burned ledger-based NFT within an additional ledger block of distributed ledger 144, along with temporal data characterizing a time or date of the burning of the ledger-based NFT, data identifying and characterizing the current owner (e.g., a wallet address of executed wallet application 106, etc.), and/or data identifying the ledger based NFT (e.g., a corresponding alphanumeric identifier) or the associated real-world or digital asset (e.g., in step 514 of FIG. 5).

For example, in step 514, registry system 130 may broadcast, across communications network 120, the burn hash, the temporal data, portions of the data identifying and characterizing the current, and/or portions of the data identifying the ledger based NFT to one or more additional computing systems. As described herein, registry system 130 and the one or more additional computing systems may collectively form a portion of a distributed-ledger network, and each of registry system 130 and the one or more additional computing systems may maintain a local version of distributed ledger 144 within a corresponding tangible, non-transitory memory. In some instances, one or more of registry system 130 and the additional computing systems may perform consensus-based operations that record the portions of the burn hash, the alphanumeric identifier, the temporal data, the portions of the data identifying and characterizing the current, and/or the portions of the data identifying the ledger based NFT within the additional one of ledger blocks 148 (e.g., based on a computed proof-of-work or proof-of-stake, etc.), which may establish an “updated” version of distributed ledger 144.

The one or more of registry system 130 and the additional computing systems may broadcast the updated version of distributed ledger 144 across communications network 120 to the other components of the distributed-ledger network. In other instances, registry system 130 (or a corresponding one of the additional computing systems) may perform operations that record the burn hash, the alphanumeric identifier, the temporal data, the portions of the data identifying and characterizing the current, and/or the portions of the data identifying the ledger based NFT within the additional one of ledger blocks 148 directly and without consensus-based processing, and may broadcast the updated version of distributed ledger 144 across communications network 120 to the other components of the distributed-ledger network.

Registry system 130 may also process the now-burned ledger-based NFT and determine whether the now-burned ledger-based NFT is associated with, a representative of, the current owner's ownership interest in a tangible, real-world asset (e.g., in step 516 of FIG. 5). If, for example, registry system 130 were to determine that the now-burned ledger-based NFT represents the current owner's ownership interest in a tangible, read-world asset (e.g., step 516; YES), registry system 130 may perform any of the exemplary processes described herein to provision, across communications network 120, an encrypted release code maintained within the now-burned ledger-based NFT to computing system of a corresponding third-party administration, such as TPA system 160 (e.g., in step 518 of FIG. 5) In some instances, described herein, TPA system 160 may decrypt the encrypted release code, and based on the decrypted release code, the third-party administrator may release one or more physical (or digital) asset or title documents associated with the real-world asset to the current owner, and the current owner may perfect the ownership interest in real-world asset, e.g., based on a countersignature on the asset or title documents. The third-party administrator may also relinquish physical possession of the real-world asset.

Additionally, or alternatively, registry system 130 may perform any of the exemplary processes described herein to that provision, to the device of the current owner (e.g., client device 102 of user 101), a digital release code that enables the current owner to access a secure, physical storage unit (e.g., document vault 174 of FIG. 1) and obtain the one or more asset or title documents associated with the real-world asset and in some instances, the real-world asset 172 (e.g., also in step 518 of FIG. 5). Registry system 130 may perform operations that transmit the now-burned ledger-based NFT across communications network 120 to a dummy wallet address associated with burned NFTs for archival storage (e.g., in step 520 of FIG. 5), and exemplary process 500 is complete in step 508.

In other examples, if registry system 130 were to determine that the now-burned ledger-based NFT represents the current owner's ownership interest in a digital asset (e.g., step 516; NO), registry system 130 may perform any of the exemplary processes described herein to release a digital asset associated with the now-burned ledger-based NFT to the current owner (e.g., in step 522 of FIG. 5). For example, the released digital asset may correspond to a metaverse asset operable within a corresponding metaverse or digital environment, and registry system 130 may perform operations, described herein, that provision the released digital asset to a device operable by the current owner across communications network 120 (e.g., also in step 522 of FIG. 5). Exemplary process 500 may pass back to step 520, and registry system 130 may transmit the now-burned ledger-based NFT across communications network 120 to a dummy wallet address associated with burned NFTs for archival storage. Exemplary process 500 is then complete in step 508.

One or more of the example processes described herein, when implemented individually or in combination by registry system 130 in conjunction with TPA system 160 and the application programs executed by client device 102 and/or client device 112, may enhance a security a and safety, and a legality, of ledger-based non-fungible tokens (NFTs) representative of an ownership of corresponding, tangible, real-world assets and additionally, or alternatively, corresponding digital assets. By way of example, the tangible, real-world assets may include, but are not limited to, parcels of real property (including land, buildings, or other improvements), vehicles (e.g., automobiles, airplanes, yachts, etc.), pieces of artwork (e.g., painting, sculptures, etc.), or other physical objects or assets. In some examples, the tangible, real-world assets may also include one or more units of a precious metal, such as gold, silver, or platinum (e.g., as physical bars, physical coins, etc.), units of raw or processed gemstones, such as diamonds, or units or other precious commodities, such as, but not limited to rare-earth metals, minerals, or materials. Further, by way of example, the digital assets may include, but are not limited to, elements of digital artwork or music, units or cryptocurrencies, or other digital assets.

Implementation examples are further described in the following numbered clauses:

1. An apparatus comprising:
a communications interface;
a memory storing instructions; and
at least one processor coupled to the communications interface and to the memory, the at least one processor being configured to execute the instructions to:
   receive, from a device via the communications interface, a request to generate a non-fungible token associated with an ownership interest in an asset, the request comprising elements of first data that characterize the ownership interest;
   receiving, from a computing system via the communications interface, elements of second data that characterize the ownership interest;
   based on a determined consistency between the elements of first and second data, perform operations that generate the non-fungible token and that record information characterizing the non-fungible token within an element of a distributed ledger; and
   perform operations that provision the non-fungible token to an application program executed by the device.
      2. The apparatus of clause 1, wherein the asset comprises a tangible asset or a digital asset, and the elements of first data characterize the ownership interest of a user associated with the device in the at least one of the tangible asset or the digital asset.
      3. The apparatus of clause 2, wherein the tangible asset comprises at least one of a parcel of real property, a physical unit of gold, or a tangible representation of at least one of an intangible asset or a digital asset.
      4. The apparatus of any of clauses 2-3, wherein:
the computing system is associated with a third-party administrator, the third-party administrator maintaining the tangible asset in accordance with an agreement between the user and the third-party administrator;
the elements of first data comprise documentary data that characterize the ownership interest of the user in the tangible asset; and
the elements of second data comprise asset data that characterizes the tangible asset and agreement data that characterizes the agreement.
   5. The apparatus of any of clauses 2-4, wherein the at least one processor is further configured to execute the instructions to:
obtain a digital representation of the tangible asset, the digital representation characterizing a current physical condition of the tangible asset; and
generate a hash value based on at least a portion of the digital representation of the tangible asset, and perform the operations that generate the non-fungible token based on the hash value, the non-fungible token comprising the hash value.
   6. The apparatus of clause 5, wherein the at least one processor is further configured to execute the instructions to:
generate linking data that associates the non-fungible token and the digital representation; and
perform the operations that generate the non-fungible token based on the hash value and the linking data, the non-fungible token comprising the hash value and the linking data.
   7. The apparatus of any of clauses 5-6, wherein the at least one processor is further configured to execute the instruction to perform operations that transmit, via the communications interface, the non-fungible token and the digital representation of the tangible asset to the device, the non-fungible token and the digital representation of the tangible asset being transmitted via a programmatic interface of the executed application program.
   8. The apparatus of any of clauses 5-7, wherein:
the digital representation comprises a three-dimensional graphical representation of the tangible asset; and
the executed application program causes the device is configured to present the three-dimensional graphical representation of the tangible asset within an interactive digital environment.
   9. The apparatus of any of clauses 1-8, wherein the information characterizing the non-fungible token comprises an alphanumeric identifier of the non-fungible token.
   10. The apparatus of any of clauses 1-9, wherein the at least one processor is further configured to execute the instructions to:
receive a request to redeem the non-fungible token from the device via the communications interface, the request comprising the non-fungible token;
based on a verified ownership interest in the asset and on a determined availability of the non-fungible token, generate a hash value representative of at least a portion of the non-fungible token, and perform operations that record the hash value and information characterizing the non-fungible token within an additional element of a distributed ledger; and
perform operations that provision encrypted data to the computing system, the computing system being configured to decrypt the encrypted data and perform operations that trigger a release of documentation data associated with the ownership interest.
   11. An apparatus comprising:
a communications interface;
a memory storing instructions; and
at least one processor coupled to the communications interface and to the memory, the at least one processor being configured to execute the instructions to:
   receive, from a device via the communications interface, a request to redeem a non-fungible token associated with an ownership interest in an asset, the request comprising the non-fungible token;
   based on the request, verify the ownership interest in the asset and that determine an availability of the non-fungible token for redemption;
   based on the verified ownership interest in the asset and on the determined availability of the non-fungible token, generate a hash value representative of at least a portion of the non-fungible token, and perform operations that record the hash value and information characterizing the non-fungible token within an element of a distributed ledger; and
   perform operations that provision encrypted data to a computing system associated with the asset, the computing system being configured to decrypt the encrypted data and perform operations that trigger a release of documentation data associated with the ownership interest.
      12. The apparatus of clause 11, wherein the asset comprises at least one of a tangible asset or a digital asset.
      13. The apparatus of any of clauses 11-12, wherein the asset comprises a tangible representation of at least one of an intangible asset or a digital asset.
      14. The apparatus of ay of clauses 11-13, wherein the asset comprises a tangible asset, and the non-fungible token comprises an additional hash value representative of a digital representation of the tangible asset, the digital representation characterizing a current physical condition of the tangible asset.
      15. The apparatus of any of clauses 11-14, wherein:
the information characterizing the non-fungible token comprises an alphanumeric identifier of the non-fungible token; and
the at least one processor is further configured to execute the instructions to:
   obtain the distributed ledger from a portion of the memory, and access at least one additional element of the distributed ledger that include the alphanumeric identifier of the non-fungible token, the at least one additional element comprising data characterizing the ownership interest in the asset; and
   verify the ownership interest in the asset based on the request and the data characterizing the ownership interest in the asset.
      16. The apparatus of any of clauses 11-15, wherein:
the information characterizing the non-fungible token comprises an alphanumeric identifier of the non-fungible token; and
the at least one processor is further configured to execute the instructions to:
   obtain alphanumeric identifiers of one or more unavailable non-fungible tokens, the unavailable non-fungible tokens comprising at least one of a stolen non-fungible token or a hacked non-fungible token; and
   determine that the non-fungible token is available for redemption when the alphanumeric identifiers of one or more unavailable non-fungible tokens fail to include the alphanumeric identifier of the non-fungible token.
      17. The apparatus of any of clauses 11-16, wherein the asset comprises a digital asset, and the at least one processor is further configured to execute the instructions to provision the digital asset to the device based on the verified ownership interest in the asset and on the determined availability of the non-fungible token.
      18. The apparatus of any of clauses 11-17, wherein the at least one processor is further configured to execute the instructions to transmit, via the communications interface, the non-fungible token to an additional device that executes an application program associated with a predetermined wallet address.
      19. An apparatus comprising:
a communications interface;
a memory storing instructions; and
at least one processor coupled to the communications interface and to the memory, the at least one processor being configured to execute the instructions to:
   receive, via the communications interface, a request to transfer a non-fungible token associated with an ownership interest in an asset from a first device to a second device, the request comprising an identifier of transfer data, data identifying the second device, and a value of at least one parameter of the transfer;
   based on portions of the request, approve the transfer of the non-fungible token, and perform operations that record information characterizing the approved transfer of the non-fungible token within an element of a distributed ledger; and
   perform operations that provision the non-fungible token to an application program executed by the second device.
      20. The apparatus of clause 19, wherein the asset comprises a tangible asset or a digital asset.

Examples of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Exemplary embodiments of the subject matter described in this specification, such as, but not limited to, platform engine 150, registry engine 152, oracle engine 154, and fractionalization engine 156, can be implemented as one or more computer programs, i.e., one or more modules of computer program instructions encoded on a tangible non-transitory program carrier for execution by, or to control the operation of, a data processing apparatus (or a computer system or a computing device).

Additionally, or alternatively, the program instructions can be encoded on an artificially generated propagated signal, such as a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The terms “apparatus,” “device,” and “system” (e.g., the FI computing system and the device described herein) refer to data processing hardware and encompass all kinds of apparatus, devices, and machines for processing data, including, by way of example, a programmable processor such as a graphical processing unit (GPU) or central processing unit (CPU), a computer, or multiple processors or computers. The apparatus, device, or system can also be or further include special purpose logic circuitry, such as an FPGA (field programmable gate array) or an ASIC (application-specific integrated circuit). The apparatus, device, or system can optionally include, in addition to hardware, code that creates an execution environment for computer programs, such as code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, such as one or more scripts stored in a markup language document, in a single file dedicated to the program in question, or in multiple coordinated files, such as files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, such as an FPGA (field programmable gate array), an ASIC (application-specific integrated circuit), one or more processors, or any other suitable logic.

Computers suitable for the execution of a computer program include, by way of example, general or special purpose microprocessors or both, or any other kind of central processing unit. Generally, a CPU will receive instructions and data from a read-only memory or a random-access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, such as magnetic, magneto-optical disks, or optical disks. However, a computer need not have such devices. Moreover, a computer can be embedded in another device, such as a mobile telephone, a personal digital assistant (PDA), a mobile audio or video player, a game console, a Global Positioning System (GPS) receiver, or a portable storage device, such as a universal serial bus (USB) flash drive.

Computer-readable media suitable for storing computer program instructions and data include all forms of non-volatile memory, media and memory devices, including by way of example semiconductor memory devices, such as EPROM, EEPROM, and flash memory devices; magnetic disks, such as internal hard disks or removable disks; magneto-optical disks; and CD-ROM and DVD-ROM disks. The processor and the memory can be supplemented by, or incorporated in, special purpose logic circuitry.

To provide for interaction with a user (e.g., the customer or employee described herein), embodiments of the subject matter described in this specification can be implemented on a computer having a display unit, such as a CRT (cathode ray tube) or LCD (liquid crystal display) monitor, a TFT display, or an OLED display, for displaying information to the user and a keyboard and a pointing device, such as a mouse or a trackball, by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, such as a data server, or that includes a middleware component, such as an application server, or that includes a front-end component, such as a computer having a graphical user interface or a Web browser through which a user can interact with an implementation of the subject matter described in this specification, or any combination of one or more such back-end, middleware, or front-end components. The components of the system can be interconnected by any form or medium of digital data communication, such as a communication network. Examples of communication networks include a local area network (LAN) and a wide area network (WAN), such as the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, such as an HTML page, to a user device, such as for purposes of displaying data to and receiving user input from a user interacting with the user device, which acts as a client. Data generated at the user device, such as a result of the user interaction, can be received from the user device at the server.

While this specification includes many specifics, these should not be construed as limitations on the scope of the invention or of what may be claimed, but rather as descriptions of features specific to particular embodiments of the invention. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

In this application, the use of the singular includes the plural unless specifically stated otherwise. In this application, the use of “or” means “and/or” unless stated otherwise. Furthermore, the use of the term “including,” as well as other forms such as “includes” and “included,” is not limiting. In addition, terms such as “element” or “component” encompass both elements and components comprising one unit, and elements and components that comprise more than one subunit, unless specifically stated otherwise. The section headings used herein are for organizational purposes only, and are not to be construed as limiting the described subject matter.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow.

Further, other embodiments will be apparent to those skilled in the art from consideration of the specification and practice of one or more embodiments of the present disclosure. It is intended, therefore, that this disclosure and the examples herein be considered as exemplary only, with a true scope and spirit of the disclosed embodiments being indicated by the following listing of exemplary claims.

What is claimed is:

1. An apparatus comprising:
a communications interface;
a memory storing instructions; and
at least one processor coupled to the communications interface and to the memory, the at least one processor being configured to execute the instructions to:
receive, from a device via the communications interface, a request to generate a non-fungible token associated with an ownership interest in an asset, the request comprising elements of first data that characterize the ownership interest;
receive, from a computing system via the communications interface, elements of second data that characterize the ownership interest;
based on a determined consistency between the elements of first and second data, perform operations that generate the non-fungible token and that record information characterizing the non-fungible token within an element of a distributed ledger; and
perform operations that provision the non-fungible token to an application program executed by the device.

2. The apparatus of claim 1, wherein the asset comprises a tangible asset or a digital asset, and the elements of first data characterize the ownership interest of a user associated with the device in the at least one of the tangible asset or the digital asset.

3. The apparatus of claim 2, wherein the tangible asset comprises at least one of a parcel of real property, a physical unit of gold, or a tangible representation of at least one of an intangible asset or a digital asset.

4. The apparatus of claim 2, wherein:
the computing system is associated with a third-party administrator, the third-party administrator maintaining the tangible asset in accordance with an agreement between the user and the third-party administrator;
the elements of first data comprise documentary data that characterize the ownership interest of the user in the tangible asset; and
the elements of second data comprise asset data that characterizes the tangible asset and agreement data that characterizes the agreement.

5. The apparatus of claim 2, wherein the at least one processor is further configured to execute the instructions to:
obtain a digital representation of the tangible asset, the digital representation characterizing a current physical condition of the tangible asset; and
generate a hash value based on at least a portion of the digital representation of the tangible asset, and perform the operations that generate the non-fungible token based on the hash value, the non-fungible token comprising the hash value.

6. The apparatus of claim 5, wherein the at least one processor is further configured to execute the instructions to:
generate linking data that associates the non-fungible token and the digital representation; and
perform the operations that generate the non-fungible token based on the hash value and the linking data, the non-fungible token comprising the hash value and the linking data.

7. The apparatus of claim 5, wherein the at least one processor is further configured to execute the instruction to perform operations that transmit, via the communications interface, the non-fungible token and the digital representation of the tangible asset to the device, the non-fungible token and the digital representation of the tangible asset being transmitted via a programmatic interface of the executed application program.

8. The apparatus of claim 5, wherein:
the digital representation comprises a three-dimensional graphical representation of the tangible asset; and
the executed application program causes the device is configured to present the three-dimensional graphical representation of the tangible asset within an interactive digital environment.

9. The apparatus of claim 1, wherein the information characterizing the non-fungible token comprises an alphanumeric identifier of the non-fungible token.

10. The apparatus of claim 1, wherein the at least one processor is further configured to execute the instructions to:
receive a request to redeem the non-fungible token from the device via the communications interface, the request comprising the non-fungible token;
based on a verified ownership interest in the asset and on a determined availability of the non-fungible token, generate a hash value representative of at least a portion of the non-fungible token, and perform operations that record the hash value and information characterizing the non-fungible token within an additional element of a distributed ledger; and
perform operations that provision encrypted data to the computing system, the computing system being configured to decrypt the encrypted data and perform operations that trigger a release of documentation data associated with the ownership interest.

11. An apparatus comprising:
a communications interface;
a memory storing instructions; and
at least one processor coupled to the communications interface and to the memory, the at least one processor being configured to execute the instructions to:
receive, from a device via the communications interface, a request to redeem a non-fungible token associated with an ownership interest in an asset, the request comprising the non-fungible token;
based on the request, verify the ownership interest in the asset and that determine an availability of the non-fungible token for redemption;
based on the verified ownership interest in the asset and on the determined availability of the non-fungible token, generate a hash value representative of at least a portion of the non-fungible token, and perform operations that record the hash value and information characterizing the non-fungible token within an element of a distributed ledger; and
perform operations that provision encrypted data to a computing system associated with the asset, the computing system being configured to decrypt the encrypted data and perform operations that trigger a release of documentation data associated with the ownership interest.

12. The apparatus of claim 11, wherein the asset comprises at least one of a tangible asset or a digital asset.

13. The apparatus of claim 11, wherein the asset comprises a tangible representation of at least one of an intangible asset or a digital asset.

14. The apparatus of claim 11, wherein the asset comprises a tangible asset, and the non-fungible token comprises an additional hash value representative of a digital representation of the tangible asset, the digital representation characterizing a current physical condition of the tangible asset.

15. The apparatus of claim 11, wherein:
the information characterizing the non-fungible token comprises an alphanumeric identifier of the non-fungible token; and
the at least one processor is further configured to execute the instructions to:
obtain the distributed ledger from a portion of the memory, and access at least one additional element of the distributed ledger that include the alphanumeric identifier of the non-fungible token, the at least one additional element comprising data characterizing the ownership interest in the asset; and
verify the ownership interest in the asset based on the request and the data characterizing the ownership interest in the asset.

16. The apparatus of claim 11, wherein:
the information characterizing the non-fungible token comprises an alphanumeric identifier of the non-fungible token; and
the at least one processor is further configured to execute the instructions to:
obtain alphanumeric identifiers of one or more unavailable non-fungible tokens, the unavailable non-fungible tokens comprising at least one of a stolen non-fungible token or a hacked non-fungible token; and
determine that the non-fungible token is available for redemption when the alphanumeric identifiers of one or more unavailable non-fungible tokens fail to include the alphanumeric identifier of the non-fungible token.

17. The apparatus of claim 11, wherein the asset comprises a digital asset, and the at least one processor is further configured to execute the instructions to provision the digital asset to the device based on the verified ownership interest in the asset and on the determined availability of the non-fungible token.

18. The apparatus of claim 11, wherein the at least one processor is further configured to execute the instructions to transmit, via the communications interface, the non-fungible token to an additional device that executes an application program associated with a predetermined wallet address.

19. An apparatus comprising:
a communications interface;
a memory storing instructions; and
at least one processor coupled to the communications interface and to the memory, the at least one processor being configured to execute the instructions to:
receive, via the communications interface, a request to transfer a non-fungible token associated with an ownership interest in an asset from a first device to a second device, the request comprising an identifier of transfer data, data identifying the second device, and a value of at least one parameter of the transfer;
based on portions of the request, approve the transfer of the non-fungible token, and perform operations that record information characterizing the approved transfer of the non-fungible token within an element of a distributed ledger; and
perform operations that provision the non-fungible token to an application program executed by the second device.

20. The apparatus of claim 19, wherein the asset comprises a tangible asset or a digital asset.
